(19) United States
(12) Patent Application Publication
(10) Pub. No.: US 2008/0294485 A1
(43) Pub. Date: Nov. 27, 2008

(54) System, method and program for supporting creating a business process

(76) Inventors: Takuya Takeuchi, Yokohama (JP); Ryota Mibe, Sagamihara (JP); Hiroshi Fujise, Yokohama (JP); Kimihito Kumazaki, Yokohama (JP); Kouzo Hatakeyama, Ayase (JP)

Correspondence Address: MCDERMOTT WILL & EMERY LLP, 600 13TH STREET, N.W., WASHINGTON, DC, 20005-3096, US

(21) Appl. No.: 11/905,164

(22) Filed: Sep. 27, 2007

(30) Foreign Application Priority Data
May 22, 2007 (JP) 2007-135554

(51) Int. Cl. G06F 17/30

(52) U.S. Cl. 705/8; 705/7

(57) ABSTRACT

A system supports creating and managing a business process model which creates a business process by: acquiring, based on a selected business, from a business element list that includes a business process template having a basic region in which processing contents are constant for each business and variable regions in which processing defined by a business element vary, as well as business elements included in a business process model, a business process template and a business element corresponding to the selected business; retrieving, based on the selected business element, a business process component that constitutes a portion of the business process model; and allocating the retrieved business process component to a variable region included in the acquired business process template.

### CLAIM OF PRIORITY

The present application claims priority from Japanese application serial no. 2007-135554 filed on May 22, 2007, the content of which is hereby incorporated by reference into this application.

### BACKGROUND OF THE INVENTION

(1) Field of the Invention

The present invention relates to a technique for accumulating business processes that include a series of work performed in a business, details of such work and a business structure, and for supporting the re-utilization of accumulated business processes.

(2) Description of Related Art

A business process model is a representation of the contents of a business process by contents of work that constitute the business, a workflow, and data used in the work.

When considering business consultation or business systemization, a designer must create a business process model in a small amount of time in order to accurately grasp the contents of business of a client. In addition, since a presentation of a business process model that approximates the contents of the client's business shall suffice in the initial stages, it is necessary that the designer create a first edition of the client's business process model as soon as possible to present it to the client.

The reutilization of previously-created business process is an effective way to expeditiously create a first edition of a business process model. Accordingly, in order to swiftly approximate the business desired by the client, a portion of elements constituting the business process model are arranged to be changeable, and components set for such a portion are prepared in advance. As a result, minute variations in the business may be accommodated by changing components to be allocated to changeable portions.

In this light, for instance, JP-A-2006-285313 proposes a method for supporting creating a business process in which relationships between a business process and components constituting the business process are hierarchized to be accumulated and managed, and a business process is retrieved using information in a hierarchical structure.

However, with the business process accumulation/retrieval system disclosed in JP-A-2006-285313, since a rule for creating components is not defined with respect to creating a component configured in a lower layer, it is necessary to independently create components capable of accommodating minute changes in the business. This results in a large number of created components.

Furthermore, in a case where components are created by a plurality of designers, there is a risk that similar components are created separately. Thus, when a different designer uses such components, there is a problem that the designer will find it difficult to determine which component should be used.

The above situation indicates that a designer must select a similar component from an extremely large number of candidates. This increases the load placed on the designer in terms of knowledge and time during selection work, and the detection of a large number of similar candidates may make it difficult to select a component.

In consideration thereof, an object of the present invention is to provide a system, a method and a program for preventing the creation of a plurality of similar components.

### SUMMARY OF THE INVENTION

The present invention comprises a processor and a storage device, wherein the storage device stores: a business element list including a business process template having a basic region in which constant processing is defined for each business and variable regions in which processing defined by a business element varies, and business elements included in a business process; and business process component information corresponding to the business elements and having business process components that constitute a portion of the business process, wherein the processor creates a business process by: accepting a selection of a business of the business process to be created; acquiring, based on the selected business, a business process template and business elements corresponding to the business from the business element list; accepting a selection of the acquired business element; retrieving, based on the selected business element, the business process component from the business process component information; and allocating the retrieved business process component to the variable region of the acquired business process template.

According to the present invention, the creation of a plurality of similar components may be prevented by classifying elements constituting a business process into fixed elements and variable elements, and using only the variable elements as components. In addition, the design load may be eased by reducing the number of similar components.

Other objects, features and advantages of the invention will become apparent from the following description of the embodiments of the invention taken in conjunction with the accompanying drawings.

### BRIEF DESCRIPTION OF THE DRAWINGS

FIG. 1 is a hardware configuration diagram of a business process creation system according to a first embodiment;

FIG. 2 is a diagram describing a relationship between a processing flow of the business process creation system, processing sections and data according to the first embodiment;

FIG. 3 is a diagram showing an example of a business process template according to the first embodiment;

FIG. 4 is a diagram showing an example of a business element list according to the first embodiment;

FIG. 5 is a diagram showing an example of business-related information according to the first embodiment;

FIG. 6A is a diagram showing an example of a business process component of an “affiliate company pattern” according to the first embodiment;

FIG. 6B is a diagram showing an example of a business process component of a “domestic company pattern” according to the first embodiment;

FIG. 7A is a diagram showing an example of a business process component of an “equipment sales pattern” according to the first embodiment;

FIG. 7B is a diagram showing an example of a business process component of a “consultation business pattern” according to the first embodiment;

FIG. 8A is a diagram showing an example of a business process component of a “counter sales pattern” according to the first embodiment;

FIG. 8B is a diagram showing an example of a business process component of a “domestic agent sales pattern” according to the first embodiment;

FIG. 9 is a diagram showing an example of a screen for selecting a business and a business element according to the first embodiment;

FIG. 10 is a diagram showing a business process model for an estimation business created by the business process creation system according to the first embodiment;

FIG. 11 is a flowchart showing details of a processing flow according to a second embodiment;

FIG. 12 is a diagram showing an example of a business process model according to the second embodiment to which a branch condition is added;

FIG. 13 is a diagram describing a relationship between a processing flow of a business process creation system, processing sections and data according to a third embodiment;

FIG. 14 is a diagram showing an example of business-related information according to the third embodiment;

FIG. 15 is a flowchart showing details of a business flow according to the third embodiment;

FIG. 16 is a flowchart showing a procedure of processing for creating a design model according to the third embodiment;

FIG. 17 is a flowchart showing a procedure of processing for creating a code according to the third embodiment;

FIG. 18 is a flowchart showing a procedure for creating a template and a component from a plurality of business process models, design models and codes according to a fourth embodiment;

FIG. 19 is a flowchart showing a procedure for creating a design model template and a design model component according to the fourth embodiment;

FIG. 20 is a flowchart showing a procedure for creating a code template and a code component according to the fourth embodiment;

FIG. 21 is a flowchart showing a procedure for presenting a recommended combination for creating a business process model according to a fifth embodiment; and

FIG. 22 is a diagram showing an example of a selection dialog for accepting business selection and creation condition input according to the fifth embodiment.

### DETAILED DESCRIPTION OF THE INVENTION

### First Embodiment

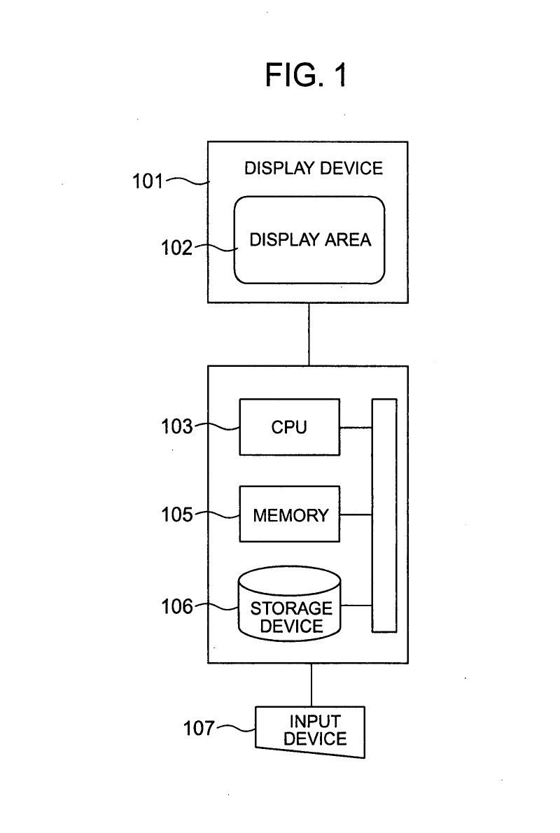

FIG. 1 is a hardware configuration diagram of a business process creation system according to a first embodiment. The business process creation system comprises a display device 101, a CPU 103, a memory 105, a storage device 106 and an input device 107.

The display device 101 is an output device for displaying information on business processes and the like. The display device 101 is, for example, a display area 102.

The CPU 103 performs various processing by executing programs stored in the memory 105. The memory 105 stores programs to be executed by the CPU 103, as well as data necessary for executing the programs. The storage device 106 stores data necessary for creating business processes.

The input device 107 is a device used by a user for inputting necessary information in order to create a business process. The input device 107 is, for example, a keyboard or a mouse.

While the business process creation system configured as shown in FIG. 1 is implemented on a single computer, the system is not limited to the configuration shown in FIG. 1. For instance, the system may be configured so that processing for creating a business process is executed by a server computer while input and display is carried out at a client computer. In this case, the server computer and the client computer are connected via a network. In addition, the storage device 106 may be installed outside of the computer that executes the processing for creating a business process, in which case data may be read and written via a network.

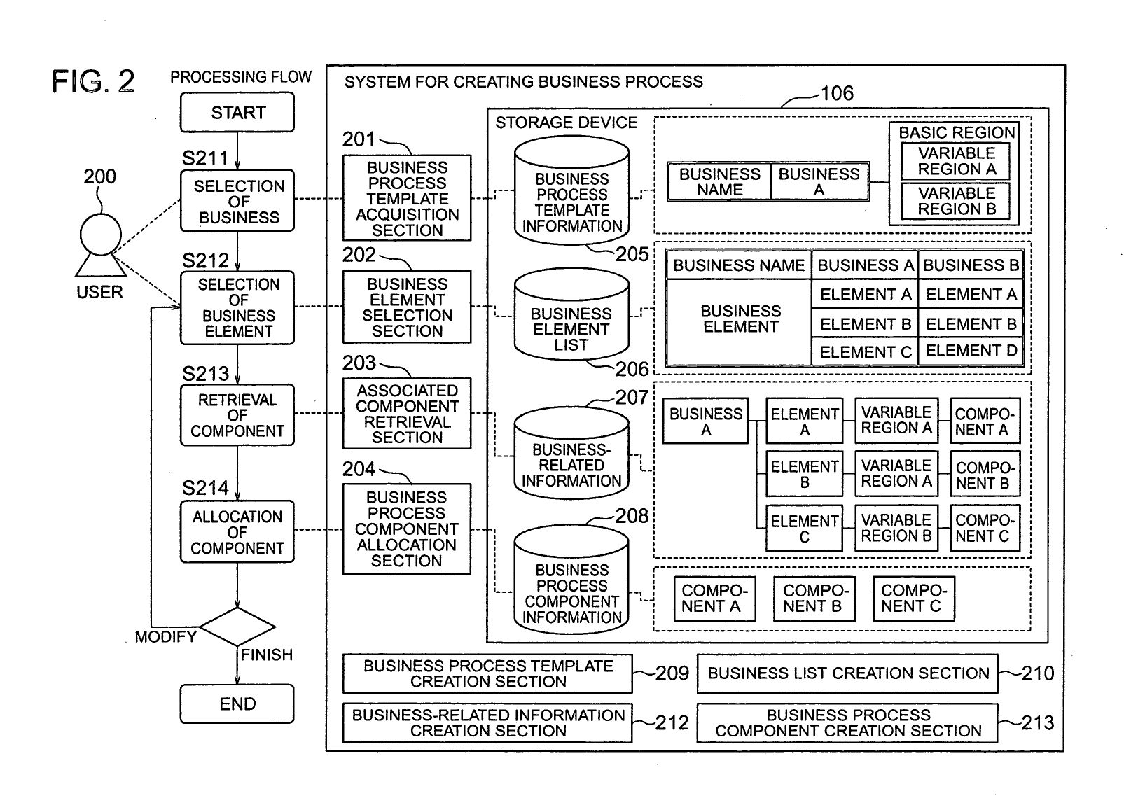

FIG. 2 is a diagram describing a relationship between a processing flow of the business process creation system, processing sections and data according to the first embodiment.

The business process creation system comprises: a business process template acquisition section 201, a business element selection section 202, an associated component retrieval section 203, a business process component allocation section 204, a business process template creation section 209, a business element list creation section 210, a business-related information creation section 212, and a business process component creation section 213. The business process template acquisition section 201, the business element selection section 202, the associated component retrieval section 203, the business process component allocation section 204, the business process template creation section 209, the business element list creation section 210, the business-related information creation section 212, and the business process component creation section 213 are programs stored in the memory 105 and executed by the CPU 103. These programs may be stored in advance in the memory 105, or stored in the storage device 106 to be loaded onto the memory 105 upon execution thereof.

Outlines of the respective processing sections will be described below. Details of each processing will be provided later together with a description of a processing flow.

The business process template acquisition section 201 acquires a business process template that complies with a condition specified by a user 200 from business process template information 205 stored in the storage device 106. A business process template is composed of a basic region in which processing contents are constant for each general business, and variable regions in which processing contents vary based on business elements, to be described later. Constant business contents are defined in advance in the basic region. In a variable region, only the start and end of processing are defined, and a business process is completed by allocating business process components, to be described later, to the variable region.

The business element selection section 202 accepts a selection of a business element stored in a business element list 206, to be described later, based on the specified business. A business element is a factor corresponding to the variable region of the business process template and which processing content varies according to business details.

Based on the business process template acquired by the business process template acquisition section 201 and the business element selected by the business element selection section 202, the associated component retrieval section 203 retrieves a business process component to be allocated to the variable region included in the business process template. A business process component is a portion of the processing of the business process which is converted into a component. As described earlier, a business process is completed by allocating business process components to all variable regions included in a business process template.

The business process component allocation section 204 allocates components retrieved by the associated component retrieval section 203 to the business process template.

The business process template creation section 209 creates a business process template, and adds the created business process template to business process template information 205 stored in the storage device 106. In addition, the business process template creation section 209 is also capable of editing and updating business process templates previously created.

The business element list creation section 210 adds data to and updates data in the business element list 206. The business-related information creation section 212 adds data to and updates data in business-related information 207.

The business process component creation section 213 newly creates a business process component, and adds the created business process component to business process component information 208 stored in the storage device 106. In addition, the business process component creation section 213 is also capable of updating created business process components.

Next, a description will be given on data stored in the storage device 106 which is used when executing the respective processing sections described above. The business process creation system comprises: the business process template information 205, the business element list 206, the business-related information 207, and the business process component information 208.

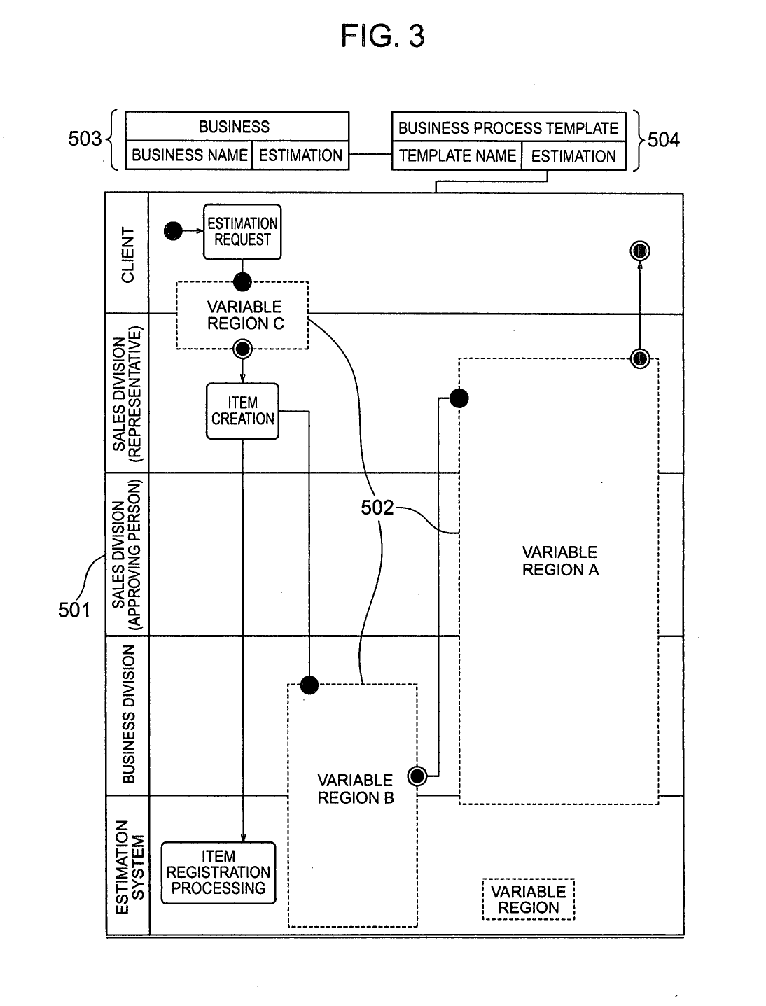

The business process template information 205 stores business process templates corresponding to various businesses. As described above, a business process template includes a basic region in which processing does not vary according to business contents and variable regions in which processing is likely to vary according to business contents. Details of a business process template will be described later with reference to FIG. 3.

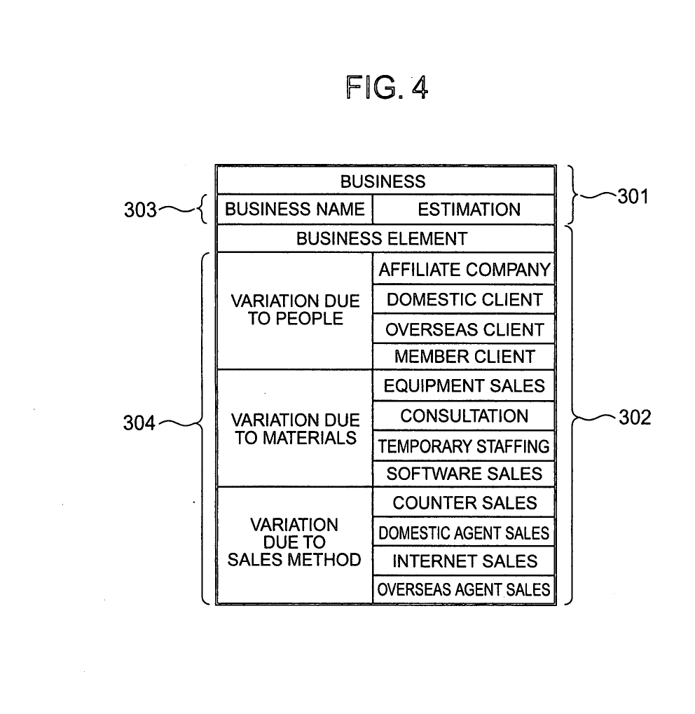

As a list of business elements, the business element list 206 stores information indicating a list of businesses and business elements. Details of the business element list 206 will be described later with reference to FIG. 4.

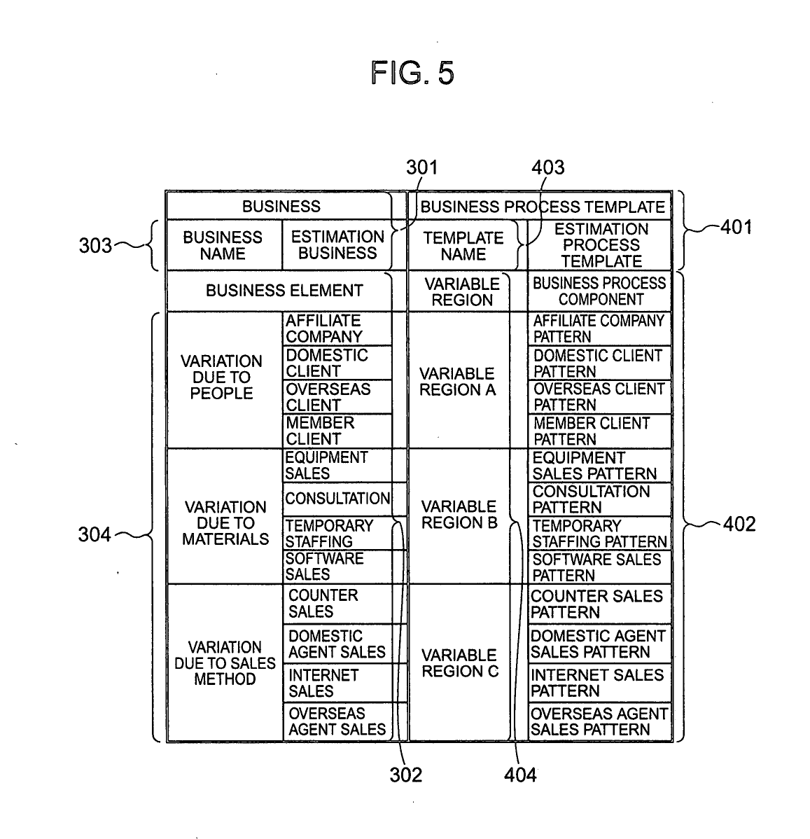

The business-related information 207 stores information related to: a business process template, the business element list 206, and business process components set in the variable regions of the business process template. Details of the business-related information 207 will be described later with reference to FIG. 5.

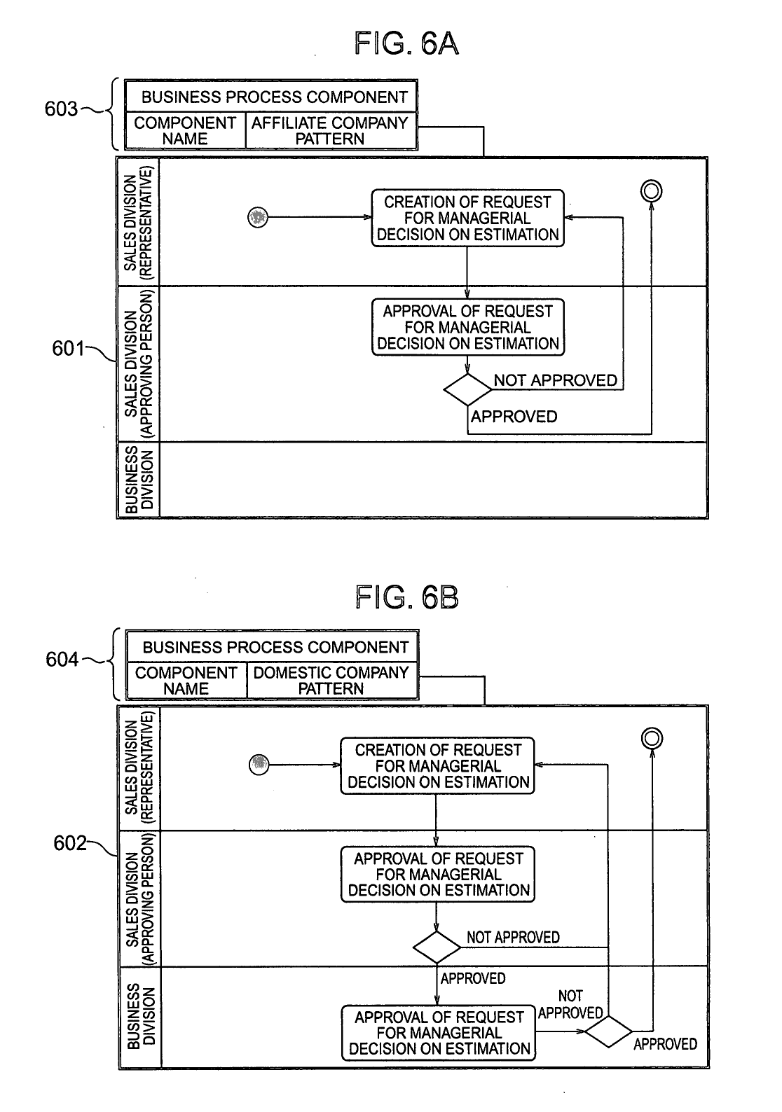

The business process component information 208 stores the substance of a business process component. Details of the business process component information 208 will be described later with reference to FIGS. 6A to 8B.

Next, details of data stored in the storage device 106 will be described.

FIG. 3 is a diagram showing an example of a business process template according to the first embodiment. A business process template is a template of a business process model that describes processing executed in a business, data, and a flow of the processing and the data. A business process template comprises: a basic region 501, variable regions 502, business information 503 and business process template information 504.

The basic region 501 is constituted by elements, among processing and data described by the business process template, which are less likely to vary according to a client and products to be sold. For instance, an estimation business normally commences when estimation is requested by a client regardless of the client or the product to be sold. Accordingly, the processing for accepting an estimation request from a client is processing that belongs to the basic region 501.

The variable regions 502 are constituted by elements, among processing and data described by the business process template, which are more likely to vary according to a client and products to be sold. In addition, unlike the basic region 501, the variable regions 502 do not include concrete processing or data, and instead, business process components are allocated thereto. By allocating a business process component to the variable regions 502, a business process corresponding to a variable factor may be created.

The business process template information 504 is an identifier for identifying a business process model as a business process template. For instance, a name of a business process template may be used.

The business information 503 is an identifier of a business to which is applied the business process template identified by the business process template information 504. In this manner, by associating business process templates with businesses, candidate business process templates may be retrieved based on a specified business.

FIG. 4 is a diagram showing the business element list 206 according to the first embodiment. The business element list 206 comprises a business 301 and business elements 302.

The business 301 stores information related to a business. More specifically, the business 301 includes a business name 303.

The business elements 302 store variable factors 304 of a business process. FIG. 4 shows an example storing business elements having “people”, “materials” and “sales method” as variable factors.

More specifically, in a variation due to “people”, the business process varies according to a client to which “materials” are sold. For instance, in a case where the sales destination is an “affiliate company”, estimation is requested, a request for managerial decision on estimation is created by a sales representative after completion of predetermined processing, and the estimation is forwarded to the client after approval of the request for managerial decision on estimation by an approving person. On the other hand, a case where the sales destination is a “domestic company” differs in that an approval must be further obtained from a business division.

In addition, although variations due to “people”, “materials” and “sales method” as the variable factors 304 of the business process have been provided as an example of a classification of the business elements 302, such classification is not limited to the example shown in FIG. 4 and may by freely determined by a designer.

FIG. 5 is a diagram showing the business-related information 207 according to the first embodiment. The business-related information 207 is retained for each business process template. The business-related information 207 comprises: a business 301, a business factor 302, a business process template 401, variable regions 404, and business process components 402.

The business 301 includes a business name 303 in the same manner as the business 301 included in the business element list 206 described with reference to FIG. 4. The business element 302 includes variable factors 304 in the same manner as the business elements 302 included in the business element list 206 described with reference to FIG. 4.

The business process template 401 stores an identifier of a business process template corresponding to the business identified by the business 301 or, more specifically, the name of the business process template.

The variable regions 404 are variable regions of the business process template to which the business process component 402, to be described later, is allocated. In addition, the variable regions 404 correspond to the variable factors 304 included in the business element 302.

The business process components 402 are business process components to be allocated to the variable regions 404. In addition, the business process components 402 correspond to the business elements 302. Details of the business process components 402 will be described later with reference to FIGS. 6A to 8B. A business process component includes business process model information and an identifier of the business process component.

While an example in which the variable factors 304 and the variable regions 404 are in an one-to-one correspondence is shown in FIG. 5, the business-related information 207 may be configured so that the variable factors 304 and the variable regions 404 are in a one-to-many or a many-to-many correspondence.

FIGS. 6A and 6B are diagrams showing examples of a business process component allocated to the variable region A shown in FIG. 3 based on a variable factor due to “people” in an estimation business. Referring to FIG. 3, it is understood that processing defined for the business process component allocated to the variable region A is executed after processing allocated to a variable region B.

FIG. 6A is a diagram showing a business process component of an “affiliate company pattern” according to the first embodiment. The “affiliate company pattern” is a business process component in an estimation business in a case where the client is an affiliate company. A business process model 601 indicates a business process model in a case where the client is an affiliate company. The name of the component, “affiliate company pattern”, is stored in an identifier 603 of the business process component.

Proceeding now to describe the business process model 601 of the “affiliate company pattern” while referring to FIG. 6A, a representative of the sales division first creates a request for managerial decision on estimation. Then, the processing defined in the business process model 601 is concluded upon approval of the request for managerial decision on estimation by an approving person of the sales division. In addition, when the request for managerial decision on estimation is not approved by the approving person of the sales division, the routine returns to the processing where a request for managerial decision on estimation is created by the representative of the sales division.

FIG. 6B is a diagram showing a business process component of a “domestic company pattern” according to the first embodiment. The “domestic company pattern” is a business process component in an estimation business in a case where the client is a domestic company that is not an affiliate company. A business process model 602 indicates a business process model in a case where the client is a domestic company that is not an affiliate company. The name of the component, “domestic company pattern”, is stored in an identifier 604 of the business process component.

Proceeding now to describe the business process model 602 of the “domestic company pattern” while referring to FIG. 6B, a representative of the sales division first creates a request for managerial decision on estimation in the same manner as in the “affiliate company pattern”. Then, upon approval of the request for managerial decision on estimation by an approving person of the sales division, the request for managerial decision on estimation must be further approved by a business division. The processing defined in the business process model 602 is concluded upon approval of the request for managerial decision on estimation by the business division. In addition, when the request for managerial decision on estimation is not approved by the approving person of the sales division or by the business division, the routine returns to the processing where a request for managerial decision on estimation is created by the representative of the sales division.

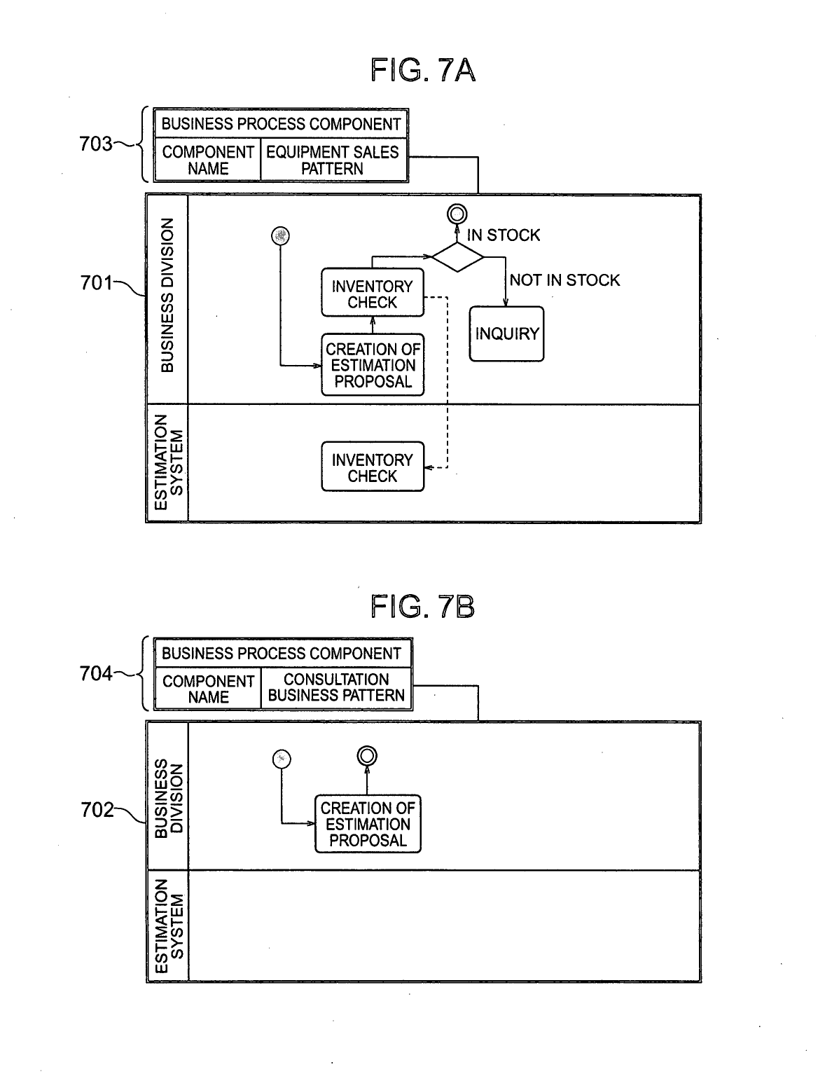

FIGS. 7A and 7B are diagrams showing examples of a business process component allocated to a variable region B shown in FIG. 3 based on a variable factor due to “materials” to be sold in an estimation business. Referring to FIG. 3, it is understood that processing defined for the business process component allocated to the variable region B is executed after processing for creating an item is performed by the representative of the sales division.

FIG. 7A is a diagram showing an example of a business process component of an “equipment sales pattern” according to the first embodiment. The “equipment sales pattern” is a business process component in an estimation business in a case where the “materials” to be sold are equipment. A business process model 701 indicates a business process model in a case where the “materials” to be sold are equipment. The name of the component, “equipment sales pattern”, is stored in an identifier 703 of the business process component.

Proceeding now to describe the business process model 701 of the “equipment sales pattern” while referring to FIG. 7A, the business division first creates an estimation proposal. Then, the inventory is checked by an estimation system. When the equipment is in stock, the processing defined in the business process model 701 is concluded. In addition, when the equipment is not in stock, an inquiry is made to a manufacturer or the like.

FIG. 7B is a diagram showing an example of a business process component of a “consultation business pattern” according to the first embodiment. The “consultation business pattern” is a business process component in an estimation business in a case of providing a service instead of selling “materials”. A business process model 702 indicates a business process model in a case where a service is provided. The name of the component, “consultation business pattern”, is stored in an identifier 704 of the business process component.

Proceeding now to describe the business process model 702 of the “consultation business pattern” while referring to FIG. 7B, the business division first creates an estimation proposal in the same manner as in the “equipment sales pattern”. In the “consultation business pattern”, since “materials” are not actually sold, an inventory check and the like are not required. The processing defined in the business process model 702 is concluded after the estimation proposal is created.

Incidentally, with the business process model 702, in a case where personnel necessary for the consultation business must be secured, processing for confirming whether it is possible to secure the necessary personnel at the same timing as the inventory check in the “equipment sales pattern” may be added to the business process model 702.

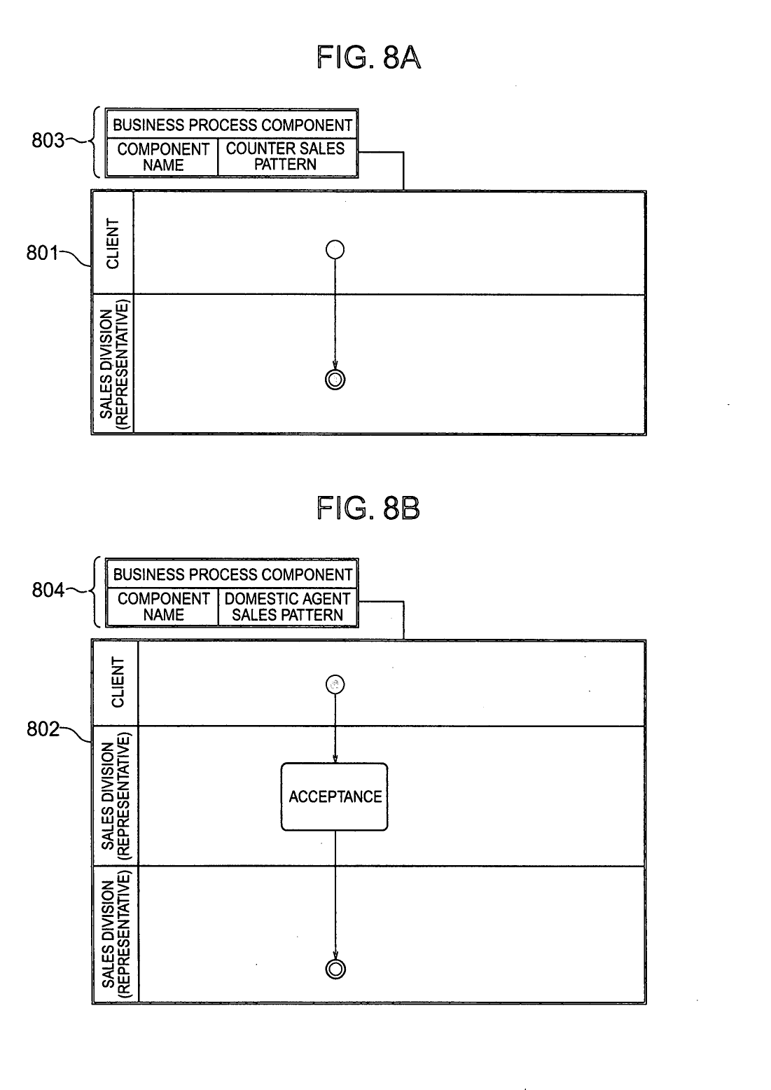

FIGS. 8A and 8B are diagrams showing examples of a business process component allocated to a variable region C shown in FIG. 3 based on a variable factor due to a “sales method” in an estimation business. Referring to FIG. 3, it is understood that processing defined by the business process component allocated to the variable region C is executed after an estimation request is made by a client.

FIG. 8A is a diagram showing an example of a business process component of a “counter sales pattern” according to the first embodiment. The “counter sales pattern” is a business process component in an estimation business in a case where an estimation request is made directly at a counter of a dealer or the like. A business process model 801 indicates a business process model in a case where the “sales method” is counter sales. The name of the component, “counter sales pattern”, is stored in an identifier 803 of the business process component. Referring now to the business process model 801, in the “counter sales pattern”, there is no processing to be executed in the variable region C.

FIG. 8B is a diagram showing an example of a business process component of a “domestic agent sales pattern” according to the first embodiment. The “domestic agent sales pattern” is a business process component in an estimation business in a case where a domestic agent performs sales. A business process model 802 indicates a business process model in a case where the “sales method” is sales by a domestic agent. The name of the component, “domestic agent sales pattern”, is stored in an identifier 804 of the business process component.

Proceeding now to describe the business process model 802 of the “domestic agent sales pattern” while referring to FIG. 8B, an estimation request is first accepted at an agent. Subsequently, a representative of the sales division is notified, thereby concluding the processing defined in the business process model 802.

A description of the configuration of the business process creation system is hereby concluded. Next, a flow of work by a user for creating a business process model will be described with reference to the processing flow shown in FIG. 2.

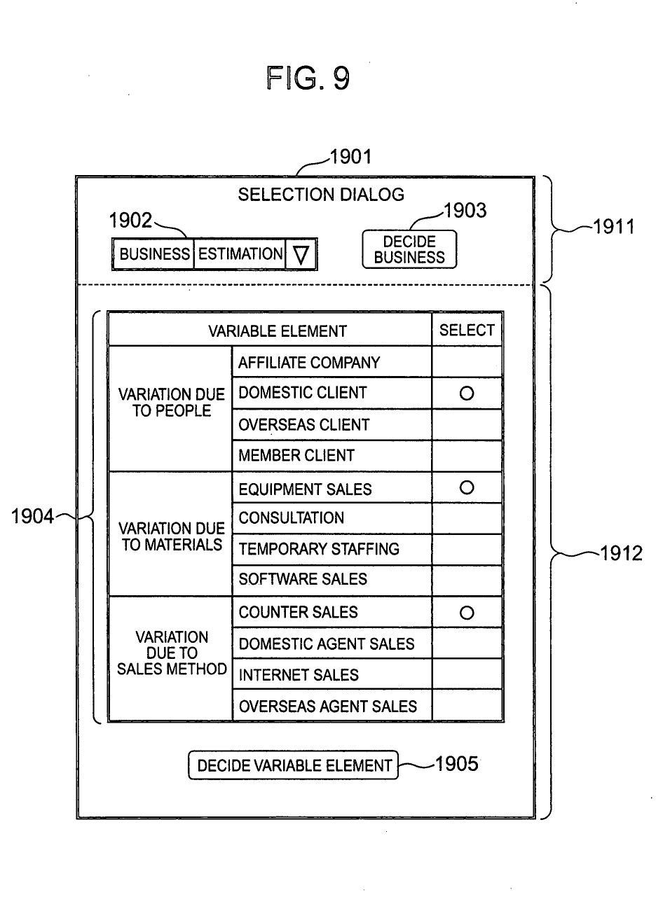

First, with respect to a business corresponding to the business process to be created, the CPU 103 accepts a selection by a user 200 via the input device 107 (S211). At this point, the CPU 103 displays a screen for selecting a business on the display area 102 by executing the business process template acquisition section 201. An example of a screen for selecting a business is shown in FIG. 9.

FIG. 9 is a diagram showing an example of a screen for selecting a business and a business element according to the first embodiment. Here, a description will be given on a business selection section 1911. A business element selection section 1912 will be described later.

The business selection section 1911 comprises a business selection combo box 1902 for selecting a business and a business decision button 1903. The business selection combo box 1902 stores business names such as estimation business. For instance, business names of business templates stored in business process template information may be extracted and stored in the business selection combo box 1902. Furthermore, business names may be extracted from the business element list 206, or a business element list may be retained separately in the storage device 106.

The user 200 selects a business corresponding to the business process to be created from the business selection combo box 1902. Subsequently, the user 200 operates the business decision button 1903 to decide the business to be selected. Referring to FIG. 9, an “estimation” business is selected in the first embodiment.

The description will now return to the processing flow shown in FIG. 2.

When a selection of a business by the user 200 is accepted, the CPU 103 acquires a business process template corresponding to the selected business from the business process template information 205 stored in the storage device 106. The acquired business process template is temporarily stored in the memory 105. Assuming that an estimation business is selected at this point, for instance, the business process template shown in FIG. 3 is acquired.

Next, the CPU 103 accepts a selection of a business element by the user 200 via the input device 107 (S212). The CPU 103 retrieves a business element from the business element list 206 stored in the storage device 106 based on the business selected through the processing of S211 by executing the business element selection section 202. An interface for accepting a selection of a business element is then displayed to accept the selection of the retrieved business element.

A more detailed description will now be given with reference to FIG. 9. A selection dialog 1901 shown in FIG. 9 includes a business element selection section 1912 that accepts a selection of a business element. The business element selection section 1912 comprises a business element list 1904 and a variable element decision button 1905.

With the selection dialog 1901, when an estimation business is selected through the processing of S211, information included in the business element list 206 for estimation business shown in FIG. 4 is displayed on the business element list 1904.

The business element list 1904 displays business elements for each variable factor. In addition, a selection field for accepting selections of business elements is provided in the business element list 1904. Referring now to FIG. 9, for “variation due to people”, “domestic company” is selected as a variable factor. In a similar manner, “equipment sales” is selected for “variation due to materials” while “counter sales” is selected for “variation due to sales method”. Incidentally, while more than one business element must be selected for each variable factor, a case where a plurality of business elements is selected for a single variable factor will be described with respect to a second embodiment.

As seen, when a business element is selected from the business element list 1904, the user 200 operates the variable element decision button 1905 to decide the business element to be selected.

Although the diagram shown in FIG. 9 depicts a single selection dialog 1901 that includes both the business selection section 1911 and the business element selection section 1912, the two sections may be presented on separate screens. Furthermore, the screen is not limited to that shown in FIG. 9 as long as the interface thereof allows similar operations to be executed.

The description will now return to the processing flow shown in FIG. 2.

Once the selection of a business element is finalized, the CPU 103 retrieves a business process component to be allocated to the variable element of the business process template based on the selected business and business element (S213). More specifically, the CPU 103 executes the associated component retrieval section 203 to search the business-related information 207 stored in the storage device 106 based on the selected business and business element. Then, the CPU 103 acquires a business process component and a variable region for allocating the business process component from the business-related information 207.

When the search of the business-related information 207 results in the retrieval of a plurality of business process components, the CPU 103 may display a screen for further accepting a selection of the retrieved business process components. Moreover, a business process component may be arranged to be selected at the moment a created business process model is displayed following the processing of S214, which will be described later.

Proceeding now to a detailed description with reference to FIG. 9, “estimation business” is selected as a business, while “domestic company”, “equipment sales” and “counter sales” are selected as business elements. Therefore, referring now to the business-related information 207 shown in FIG. 5, based on the selected business elements, a business process component of a “domestic company pattern” is retrieved for the variable region A, while a “equipment sales pattern” is retrieved for the variable region B and a “counter sales pattern” is retrieved for the variable region C.

Once the retrieval of the business process components is completed, the CPU 103 allocates the retrieved business process components to the business process template already acquired (S214). More specifically, the CPU 103 executes the business process component allocation section 204 to acquire the substances of the business process components retrieved through the processing of S213 from the business process component information 208 stored in the storage device 106.

Furthermore, the CPU 103 creates a business process model by allocating the acquired business process components to the variable regions of the acquired business process template.

Finally, the CPU 103 displays the created business process model via the display device 101. The user 200 references the displayed business process model to determine whether a change should be made. If a change is necessary, processing is re-executed starting with the selection of a business element in S212.

As described earlier, when the search of the business-related information 207 performed through the processing of S213 results in the retrieval of a plurality of business process components, a variable region of the displayed business process model may be specified to allow selection of a retrieved business process components.

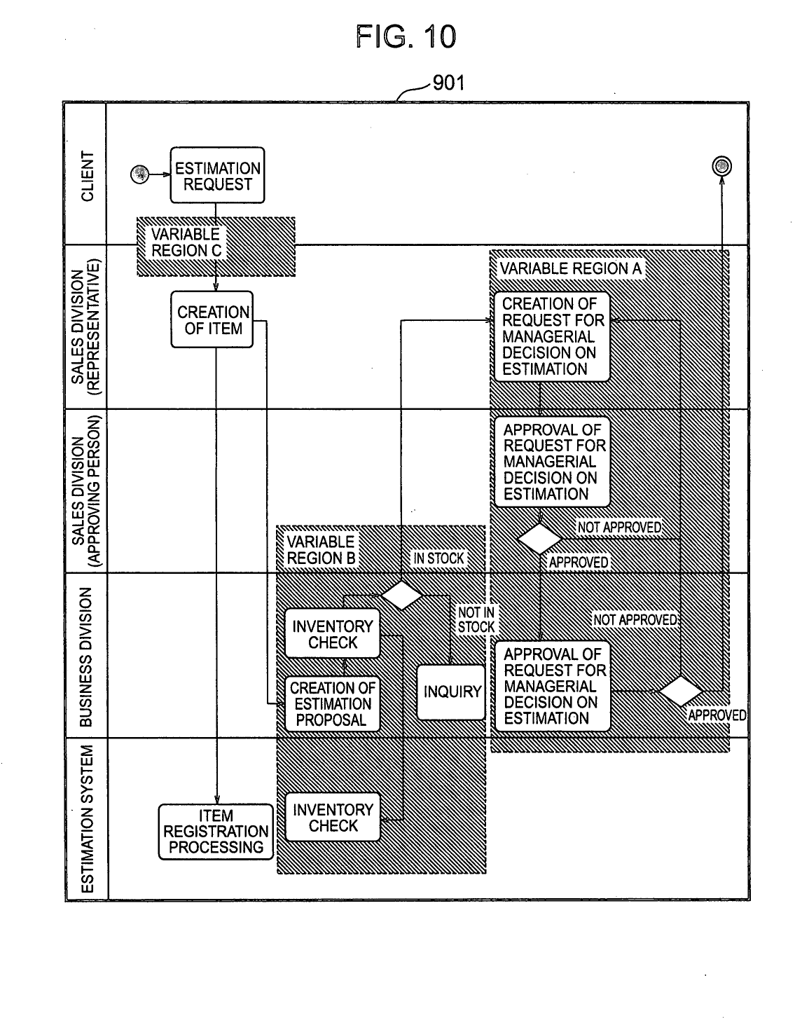

FIG. 10 is a diagram showing a business process model 901 for an estimation business created by the business process creation system according to the first embodiment. The business process model 901 is created based on information set in the selection dialog shown in FIG. 9.

In the processing of S211, “estimation business” is selected as a business and an “estimation process template”, which is a corresponding business process template, is acquired. Incidentally, in the first embodiment, it is assumed that the “estimation process template” is the business process template shown in FIG. 3.

Next, referring to FIG. 9, “domestic company”, “equipment sales” and “counter sales” are selected through the processing of S212 as business elements. At this point, operating the variable element decision button causes the processing of S213 to be executed by the CPU 103 and a corresponding business process component is retrieved. Referring to FIG. 4, the specific business process components to be retrieved are, as described above, “domestic company pattern” for the variable region A, “equipment sales pattern” for the variable region B, and “counter sales pattern” for the variable region C.

Furthermore, in the processing of S214, a business process component is allocated to each variable region 502 based on the retrieval results of the processing of S213. More specifically, “domestic company pattern” is allocated to the variable region A of the estimation process template shown in FIG. 3, “equipment sales pattern” to the variable region B thereof, and “counter sales pattern” to the variable region C thereof. In addition, as concrete examples of retrieved business process components, “domestic company pattern” is shown in FIG. 6B, “equipment sales pattern” is shown in FIG. 7A, and “counter sales pattern” is shown in FIG. 8A.

The business process model 901 shown in FIG. 10 can be created according to the processing described above. The created business process model is stored in the storage device 106 or the like.

According to the first embodiment, the conversion of a portion of a business process into a component using business elements defined as elements likely to vary during the actual performance of business enables a designer to create a business process in an easy manner by selecting a business and business elements.

In addition, according to the first embodiment, the creation of a business process model by allocating a business process component created in advance to a variable region of a business process template enables reduction of the amount of time required to create the business process model. Furthermore, it is now possible to respond to changes occurring in the business in a prompt manner.

Moreover, according to the first embodiment, by preparing components so as to correspond to the variable regions of a business process template, the redundant creation of similar components may be prevented, thereby reducing the total number of business process components. Therefore, the load placed on the designer in terms of knowledge and time during selection work may be reduced.

### Second Embodiment

In the first embodiment, one business process component was allocated to one variable region. However, a second embodiment is characterized in that a plurality of business process components is allocatable to one variable region. Hereinafter, descriptions will be omitted on configurations and processing that is shared with the first embodiment, and only points that differ will be described.

The hardware configuration of the second embodiment is the same as that of the first embodiment as shown in FIG. 1. In addition, processing sections and data constituting the business process creation system according to the second embodiment is the same as that of the first embodiment.

Furthermore, the processing flow shown in FIG. 2 is roughly the same, with the exception of a portion of the processing for allocating business process components.

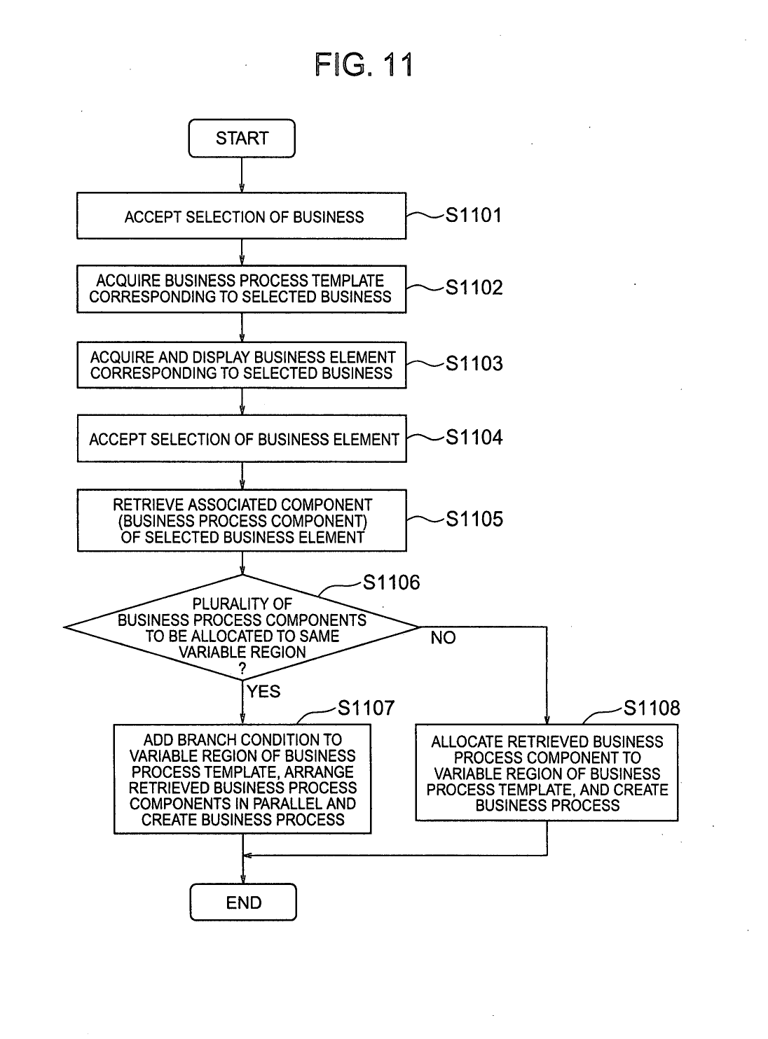

FIG. 11 is a flowchart showing details of a processing flow according to the second embodiment.

The CPU 103 first accepts a selection of a business by the user 200 (S211, S1101). At this point, for example, the screen shown in FIG. 9 is displayed in order to accept business selection. Then, based on the selected business, a business process template is acquired from the business process template information 205 (S1102). The above processing is the same as the first embodiment. The processing of S211 shown in FIG. 2 is equivalent to a combination of the processing of S1101 and S1102 shown in FIG. 11.

Next, the CPU 103 accepts a selection of a business element by the user (S212). At this point, the CPU 103 executes the business element selection section 202, and based on the selected business, displays a list of business elements acquired from the business element list 206 on the screen shown in FIG. 9 (S1103). The CPU 103 then accepts a selection of a business element by the user 200 (S212, S1104). The above processing is also the same as the first embodiment. The processing of S212 shown in FIG. 2 is equivalent to a combination of the processing of S1103 and S1104 shown in FIG. 11.

At this point, in the second embodiment, a plurality of business elements included in the same variable factor may be selected at a business element selection section 1912 shown in FIG. 9.

Subsequently, based on the selected business elements, the CPU 103 retrieves components related to the business or, in other words, business process components (S214, S1105). The present processing is also the same as in the first embodiment.

Finally, based on information retrieved through the processing of S213, the CPU 103 acquires the substance of business process components from the business process component information, and allocates the same to the variable regions of the business process template acquired through the processing of S1102 (S214).

With respect to business elements selected through the processing of S1104, the CPU 103 determines whether a plurality of business process components will be allocated to the same variable region (S1106). In the case where a plurality of business process components will be allocated to the same variable region (a “YES” result in S1106), a branch condition is added to arrange the business process components in parallel when combining the business process components with the business process template (S1107). On the other hand, in the case where a single business process component will be allocated to the same variable region (a “NO” result in S1106), the business process component is allocated to the specified variable region in the same manner as in the first embodiment (S1108). As seen, the processing of S214 shown in FIG. 2 corresponds to the processing of S1106, S1107 and S1108 shown in the flowchart of FIG. 11.

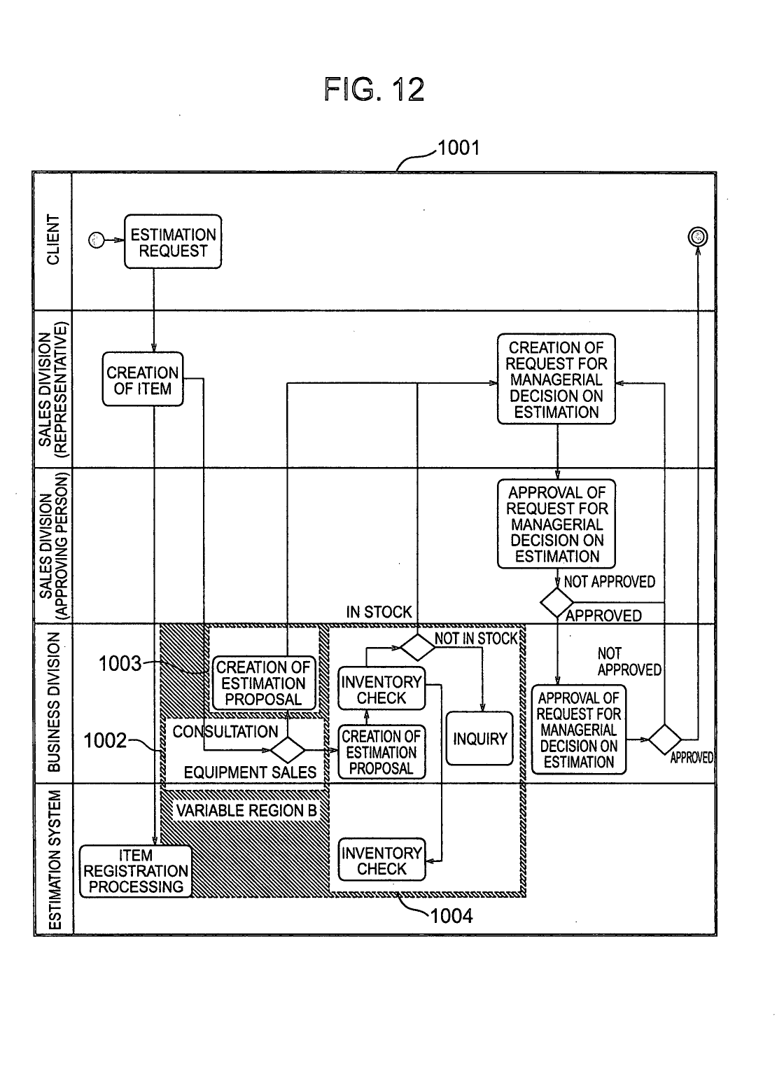

FIG. 12 is a diagram showing an example of a business process model to which a branch condition is added according to the second embodiment.

A business process model 1001 shown in FIG. 12 reflects a case where the business elements of “equipment sales” and “consultation” are redundantly allocated to a variable region B. Note that the variable regions A and C are the same as in the first embodiment.

In the second embodiment, when accepting a selection of a business element in the processing of S1104 shown in FIG. 11, both “equipment sales” and “consultation” are selected as variable factors due to “materials”.

In this manner, in the case where to business process components are allocated to a single variable region (a “YES” result in S1106 of FIG. 11), a branch condition (reference numeral 1002 in FIG. 12) is added and the respective business process components are allocated (S1107).

Proceeding now to a description with reference to FIG. 12, the branch condition 1002 is first added to the variable region B. A business process component 1003 of the “equipment sales pattern” and a business process component 1004 of the “consultation pattern” are allocated in parallel to the branch destinations. The contents of the business process component 1003 of the “equipment sales pattern” are as shown in FIG. 7A, while the contents of the business process component 1004 of the “consultation pattern” are as shown in FIG. 7B.

Incidentally, in regards to a format for depicting branch conditions, the branch condition 1002 is expressed using a rhombic symbol in accordance with the notational system of UML (Unified Modeling Language). However, another symbol in a notation system other than UML or another expression in the UML notation system may be used as long as the symbol or the expression conveys the same meaning.

According to the second embodiment, a plurality of business process components may be allocated to a single variable region. Therefore, in a case of creating a business process model using a business process template having a plurality of variable regions, aggregation to a single business process model may be achieved even when the business process component to be allocated is the same with the exception of a portion of variable regions. By aggregating similar business process models in this manner, a reduction in the management cost of business process models may be achieved.

### Third Embodiment

For the first and second embodiments, business process creation systems that create the business process models shown in FIGS. 10 and 12 have been presented. Conversely, business process creation system according to a third embodiment is characterized in that the system is provided with a function for creating a design model and a program code (hereinafter referred to as “code”).

A design model is a model for creating software that implements the system based on an analysis model such as a business process model. A deliverable thereof is, for instance, a system specification to be used for creating a program code. More specifically, a class diagram described in accordance with UML corresponds to a deliverable.

A program code is a program describing processing that is actually executable by a computer. For example, a program code is described in a programming language such as JAVA (registered trademark, ditto hereinafter).

The hardware configuration of the third embodiment is the same as that of the first embodiment shown in FIG. 1. Hereinafter, a description of processing sections and data constituting the business process creation system according to the third embodiment will be provided, with an emphasis on points that differ from the first embodiment.

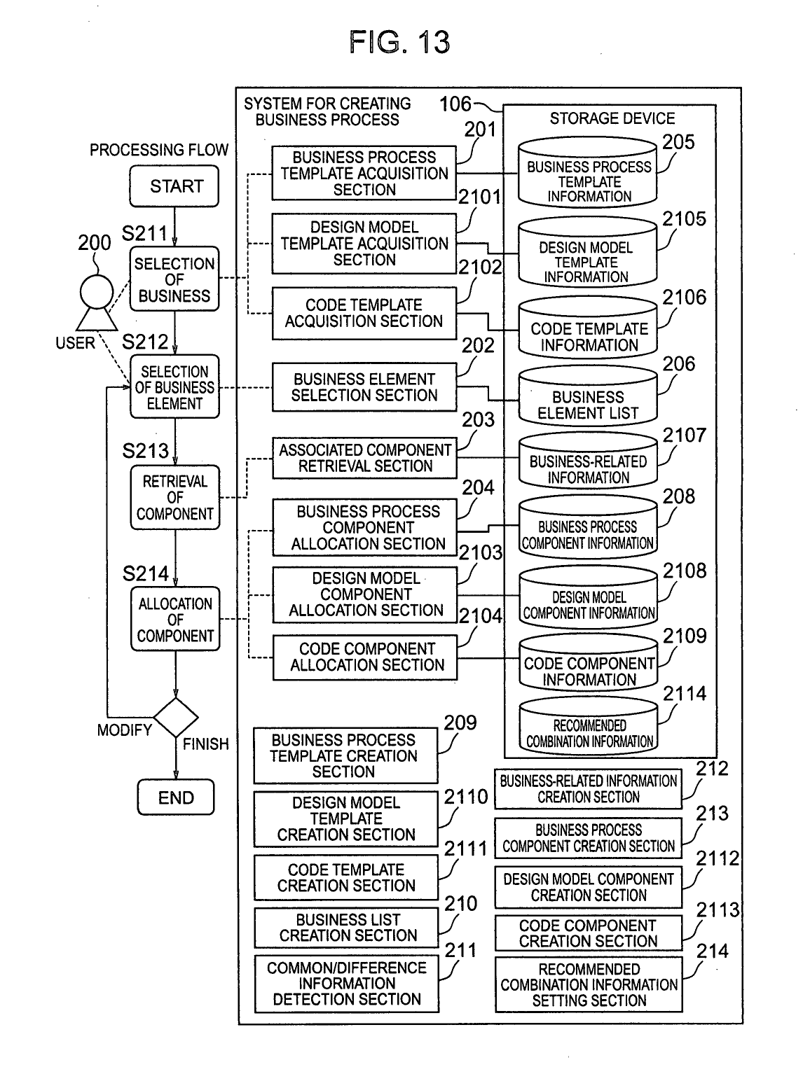

FIG. 13 is a diagram describing a relationship between a processing flow of the business process creation system, processing sections and data according to the third embodiment. Configurations that are shared with the diagram shown in FIG. 2 are assigned like reference numerals, and descriptions thereof will be omitted.

Processing sections of the business process creation system according to the third embodiment include: a program defining processing for executing a processing flow for creating a business process model or the like; and a program defining processing for creating templates and components. The program used to create a business process model is the same as in the first embodiment.

In addition to a configuration for creating a business process model, the program defining processing for executing a processing flow includes a program for creating design models and codes. More specifically, the program includes: a design model template acquisition section 2101, a code template acquisition section 2102, a design model component allocation section 2103, and a code component allocation section 2104.

The design model template acquisition section 2101 acquires a design model template that complies with a specified condition from design model template information 2105 stored in the storage device 106. The code template acquisition section 2102 acquires a code template that complies with a specified condition from code template information 2106 stored in the storage device 106.

The design model component allocation section 2103 allocates components retrieved by the associated component retrieval section 203 to a design model template. The code component allocation section 2104 allocates components retrieved by the associated component retrieval section 203 to a code template.

On the other hand, in addition to a configuration for creating a business process model, the program defining processing for creating templates and components includes a program for creating design models and codes.

A design model template creation section 2110 creates a design model template, and adds the design model template to the design model template information 2105 stored in the storage device 106. In addition, the design model template creation section 2110 is also capable of editing and updating design model templates previously created.

A code template creation section 2111 creates a code template, and adds the code template to the code template information 2106 stored in the storage device 106. In addition, the code template creation section 2111 is also capable of editing and updating code templates previously created.

A design model component creation section 2112 newly creates a design model component, and adds the design model component to the design model component information 2108 stored in the storage device 106. In addition, the design model component creation section 2112 is also capable of editing and updating design model components previously created.

A code component creation section 2113 newly creates a code component, and adds the code component to the code component information 2109 stored in the storage device 106. In addition, the code component creation section 2113 is also capable of editing and updating code components previously created.

In addition, the business element list creation section 210 is the same as that of the first embodiment. Since business-related information 2107 according to the third embodiment is configured such that information on design models and codes are added to the business-related information 207 according to the first embodiment, the business-related information creation section 212 is now capable of adding and updating business-related information on design models and codes.

The processing sections of the business process creation system further comprise a common/difference information detection section 211 and a recommended combination information setting section 214. The common/difference information detection section 211 will be described in detail with a fourth embodiment. In addition, the recommended combination information setting section 214 will be described in detail with a fifth embodiment.

Next, a description will be given on data stored in the storage device 106 which is used when executing the respective processing sections described above. In addition to the configuration of the first embodiment, the business process creation system further includes information for creating design models and codes. More specifically, the system includes: the design model template information 2105, the code template information 2106, the design model component information 2108, the code component information 2109, and recommended combination information 2114. The recommended combination information 2114 will be described in detail with a fifth embodiment.

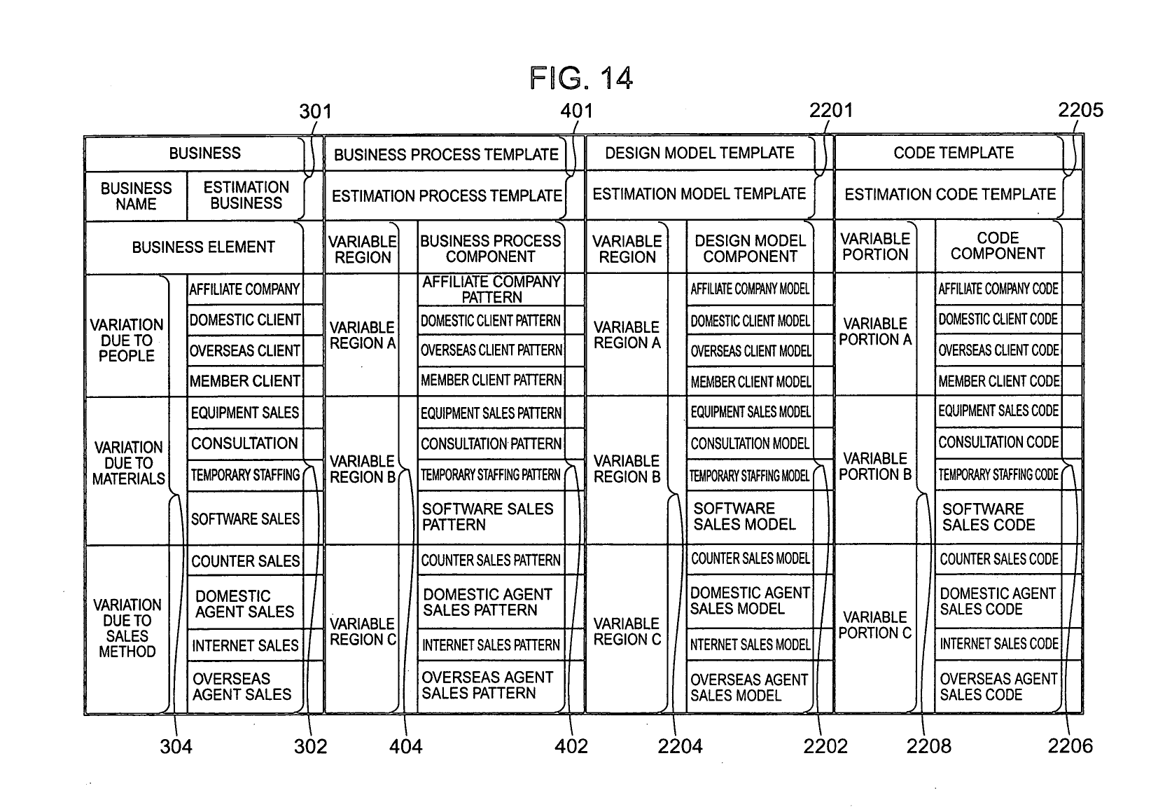

In addition, since design models and codes have been added as objects to be created by the business process creation system, the business-related information 2107 is denoted by a different reference numeral from the first embodiment. For the business-related information 2107, information on a relationship between a business and design models and codes are added to the business-related information 207 according to the first embodiment. Details thereof will be described later with reference to FIG. 14.

The design model template information 2105 stores design model templates corresponding to businesses. In the same manner as a business process template, a design model template includes a basic region in which a design element does not vary according to business contents and variable regions in which a design element is likely to vary according to business contents. The design model component information 2108 stores components to be allocated to the variable regions of a design model template.

More specifically, in a case of creating a design model with respect to an estimation business, when a class diagram is set as a design model to be created as a deliverable, it is conceivable that an “estimation proposal” class that is inevitably created belongs to a basic region. On the other hand, an “inventory” class that is used in “equipment sales” but is not used when providing a “consultation” service may be considered as being a design model component to be allocated to a variable region.

The code template information 2106 stores code templates corresponding to businesses. In the same manner as a business process template, a code template includes a basic region in which processing is less likely to vary according to business contents and variable regions in which processing is specified according to business contents. The code component information 2109 stores components to be allocated to the variable regions of a code template.

More specifically, in a case where a program code is to be created using JAVA, a class that is commonly used in the respective businesses corresponds to a basic region. In addition, a program code defining specific processing according to business contents, a variable declaration section used in the program code and the like may be considered code components.

Incidentally, a created program code need not be completely executable on its own. Instead, only a portion related to a business may be created. Furthermore, when creating a code, a code template or a code component may be defined according to the execution environment or the like in addition to business contents.

FIG. 14 is a diagram showing the business-related information 2107 according to the third embodiment. The business-related information 2107 is retained for each business.

In addition to information related to a business 301, to business elements 302 and a business process, the business-related information 2107 includes information related to design models and codes. The business-related information 2107 encompasses the business-related information 207 according to the first embodiment described with reference to FIG. 5. Thus, descriptions on portions shared with the business-related information 207 according to the first embodiment will be omitted.

Information related to a design model includes a design model template 2201, variable regions 2204 and design model components 2202.

The design model template 2201 stores an identifier of a design model template corresponding to the business identified by the business 301 or, more specifically, a name of the design model template.

The variable regions 2204 are variable regions of the design model template to which the design model components 2202 are allocated. The design model components 2202 are design model components to be allocated to the variable regions 2204 of the design model template.

Information related to a code includes a code template 2205, variable regions 2207 and code components 2206.

The code template 2205 stores an identifier of a code template corresponding to the business specified by the business 301. More specifically, the code template 2205 stores a name of the code template.

The variable regions 2207 are variable regions of the code template to which the code components 2206 are allocated. The code components 2206 are code components to be allocated to the variable regions 2207 of the code template.

Incidentally, the variable factors 304 of the business element need not strictly correspond to the variable regions 404 of the business process template, the variable regions 2204 of the design model template or the variable regions 2207 of the code template. For example, the variable factors 304 may be included in variable regions when creating a business process, and may be included in a basic region when creating a design model. More specifically, in a business process, the variable factors 304 may be included in variable regions due to the difference in flow. However, in a design process, the variable factor 304 may be included in a basic region because the defined class is shared.

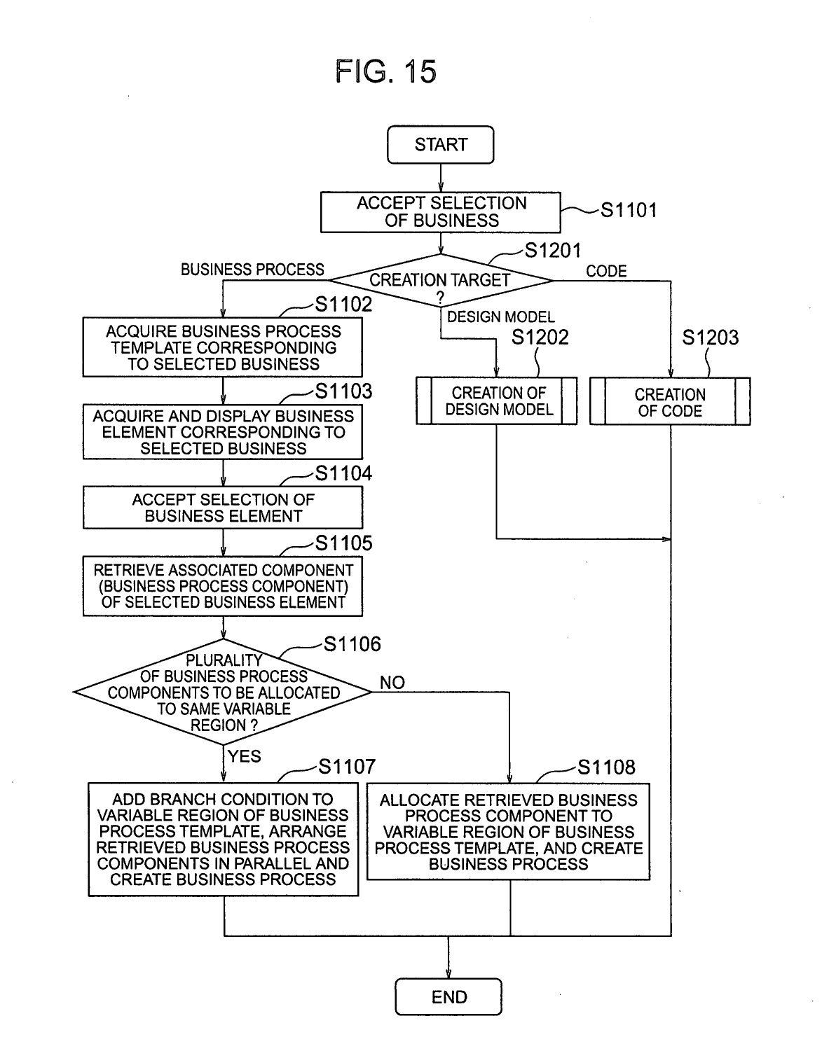

FIG. 15 is a flowchart showing details of a processing flow according to the third embodiment. Since the processing for creating a business process is the same as in the second embodiment, like processing will be denoted by like reference numerals and descriptions thereof will be omitted.

The CPU 103 first accepts a selection of a business by the user (S1101). In the third embodiment, an input of an object to be created is accepted (S1201). More specifically, an input is accepted regarding which of a business process, a design model and a code will be created. Moreover, a plurality among or all of a business process, a design model and a code may be arranged to be selectable.

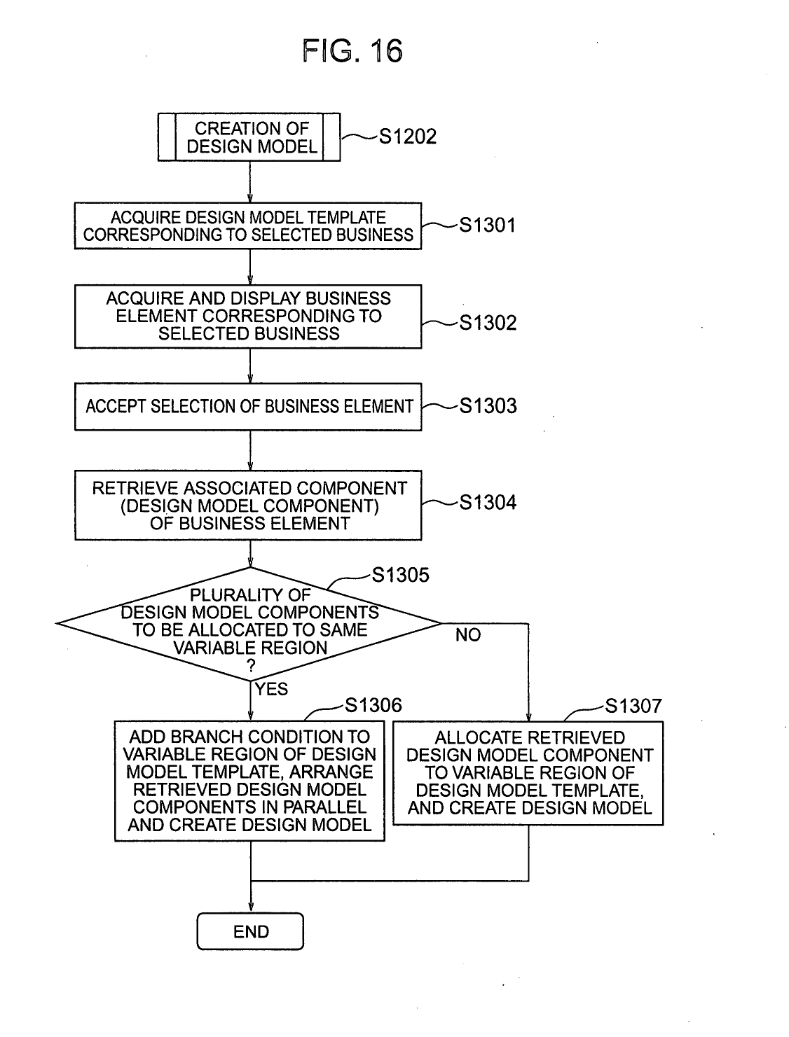

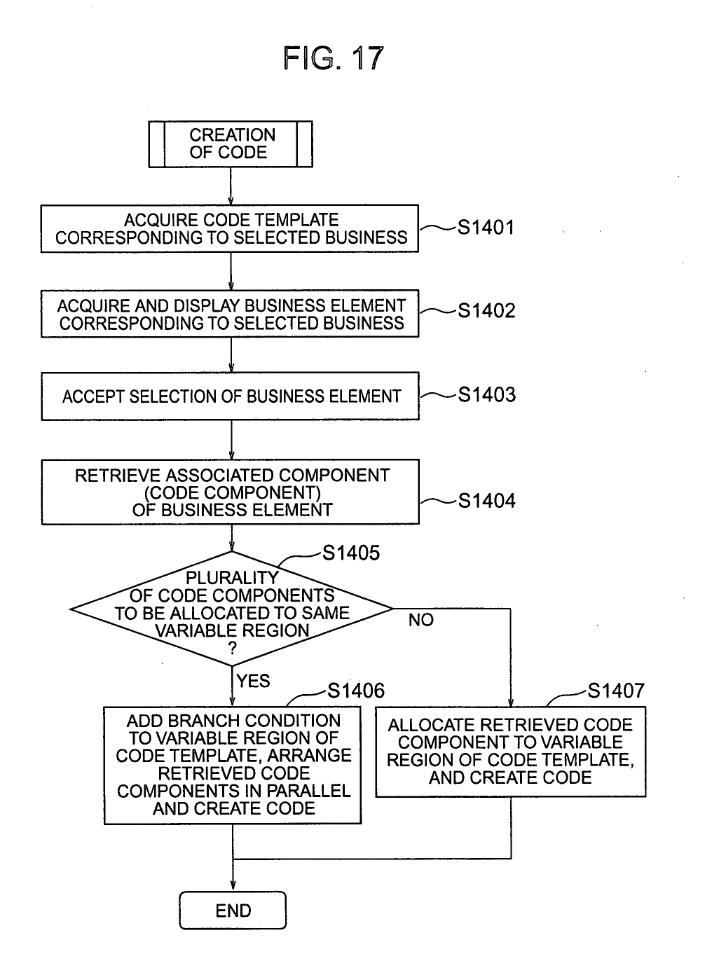

Based on the contents selected through the processing of S1201, the CPU 103 creates the specified object. When creating a business process, the contents are the same as those described for the second embodiment. When creating a design model, design model creation processing S1202 is executed. When creating a code, code creation processing S1203 is executed. The design model creation processing S1202 will be described with reference to FIG. 16. In addition, the code creation processing S1203 will be described with reference to FIG. 17.

FIG. 16 is a flowchart showing a procedure of the design model creation processing S1202 according to the third embodiment. The basic procedure is the same as the procedure for creating a business process.

The CPU 103 executes the design model template acquisition section 2101, and based on the selected business, acquires a design model template (S1301). More specifically, the CPU 103 acquires a design model template corresponding to the selected business from the design model template information 2105 stored in the storage device 106. The acquired design model template is temporarily stored in the memory 105. Assuming that an estimation business is selected at this point, for instance, the design model template 2201 (estimation model template) shown in FIG. 14 is acquired.

The CPU 103 executes the business element selection section 202, and displays a list of business elements from the business element list 206 (S1302). At this point, in the same manner as the processing for creating a business process model, the CPU 103 displays a screen for accepting a selection of a business element as shown in FIG. 9, and accepts a selection of a business element by the user 200 (S212, S1303).

Next, the CPU 103 executes the associated component retrieval section 203, acquires related information stored in the business-related information 2107 based on the selected business element, and retrieves a design model component related to the business element as well as a variable region for allocating the design model component (S213, S1304).

Finally, the CPU 103 executes the design model component allocation section 2103, and based on the retrieved design model component and information on the variable region to which the design model component is to be allocated, acquires the substance of the design model component from the design model component information 2108. Subsequently, a design model is created by allocating the design model component to the variable region of the acquired design model template (S1307).

Moreover, in the case of allocating a plurality of design model components to the same variable region (a “YES” result in S1305), a branch condition is added to arrange the design model components in parallel when allocating the retrieved design model components to the design model template (S1306).

Incidentally, a design model, as well as a design model template and a design model component which are partial information constituting a design model, are information representing a modelization of a software program structure. Accordingly, design models, design model templates and design model components described using a design language such as UML have been assumed as described earlier. However, arrangements are not limited to this example as long as a software program structure may be expressed. In addition, expressions of a branch condition in a design model are also not limited to any particular arrangement as long as such expressions are capable of indicating a branch in the software program structure.

FIG. 17 is a flowchart showing a procedure of code creation processing S1203 according to the third embodiment. The basic procedure is the same as the procedure for creating a business process.

The CPU 103 executes the code template acquisition section 2102, and based on the selected business, acquires a code template (S1401). More specifically, the CPU 103 acquires a code template corresponding to the selected business from the code template information 2106 stored in the storage device 106. The acquired code template is temporarily stored in the memory 105. Assuming that an estimation business is selected at this point, for instance, the code template 2205 (estimation code template) shown in FIG. 14 is acquired.

The CPU 103 executes the business element selection section 202, and displays a list of business elements from the business element list 206 (S1402). At this point, in the same manner as the processing for creating a business process model, the CPU 103 displays a screen for accepting a selection of a business element as shown in FIG. 9, and accepts a selection of a business element by the user 200 (S212, S1403).

Next, the CPU 103 executes the associated component retrieval section 203, acquires related information stored in the business-related information 2107 based on the selected business element, and retrieves a code component related to the business element as well as a variable region for allocating the code component (S213, S1404).

Finally, the CPU 103 executes the code component allocation section 2104, and based on the retrieved design model component and information on the variable region to which the code component is to be allocated, acquires the substance of the code component from the code component information 2109. Subsequently, a code is created by allocating the code component to the variable region of the acquired code template (S1407).

Moreover, in the case of allocating a plurality of code components to the same variable region (a “YES” result in S1405), a branch condition code such as an if statement is added to arrange the code components in parallel when allocating the retrieved code components to the code template (S1406).

A code, as well as a code template and a code component which are partial information constituting a code are software source codes. Therefore, it has been assumed that codes, code templates and code components are described using a program language such as JAVA. However, another programming language may be used. In addition, while an if statement is cited as an example of an expression of a branch condition, the expression may be determined in accordance with the used programming language.

According to the third embodiment, it is now possible to create a design model or a program code in addition to a business process. Therefore, improvements can be made not only on the efficiency of business analysis but on the efficiency of system development as well. Furthermore, since the relationship between a business process that is a result of business analysis, and a design model corresponding to the design of a system and a program code corresponding to the implementation of the system may be clarified, dissociation of the analysis result from the implemented system may be prevented.

### Fourth Embodiment

Examples of creating a business process model or the like have been described for the first to third embodiments. For a fourth embodiment, an example will be described in which a business process template and a business process component are created based on a plurality of already-created business process models. In addition, an example will be described in which a design model template and a design model component, a code template and a code component are created.

The hardware configuration of the fourth embodiment is the same as that of the first embodiment shown in FIG. 1. Hereinafter, points of processing sections and data constituting a business process creation system according to the fourth embodiment which differ from the first to third embodiments will be described.

A software configuration of the business process creation system according to the fourth embodiment is the same as that of the business process creation system according to the third embodiment shown in FIG. 13.

As described above, in the fourth embodiment, a business process template and a business process component are created based on a plurality of already-created business process models.

The common/difference information detection section 211 detects common portions and difference portions by comparing, based on information on the plurality of business process models, the contents of work carried out in a business, business data, work sequence and branch conditions included in each business process model.

In addition, common/difference information detection section 211 detects common portions and difference portions among design models by comparing, based on information on the plurality of design models, the contents of data processing, data items, flow of data processing and contents of branch conditions described in each design model.

Furthermore, common/difference information detection section 211 detects common portions and difference portions by comparing, based on information on the plurality of codes, the contents of data processing, data items, flow of data processing and contents of branch conditions described in each code. In this case, when the same business or processing included in a business is handled as a different business or processing by a client or the like, a correspondence table including the correspondence relationship between businesses or processing to be handled differently is preferably retained in advance.

The business process template creation section 209 creates a business process model template based on information on a common portion of business process models detected by the common/difference information detection section 211, and stores the created business process model template into the business process template information 205. Moreover, the business process template creation section 209 may be equipped with a function that allows the user to create a business process template as described above for the first embodiment.

The design model template creation section 2110 creates a design model template based on information on a common portion of design models detected by the common/difference information detection section 211, and stores the created design model template into the design model template information 2105. Moreover, the design model template creation section 2110 may be equipped with a function that allows the user to create a design model template.

The code template creation section 2111 creates a code template based on information on a common portion of codes detected by the common/difference information detection section 211, and stores the created code template into the code template information 2106. Moreover, the code template creation section 2111 may be equipped with a function that allows the user to create a code template.

The business process component creation section 213 creates a business process component based on information on a difference portion of business process models detected by the common/difference information detection section 211, and stores the created business process component into the business process component information 208. Moreover, the business process component creation section 213 may be equipped with a function that allows the user to create a business process component as described above for the first embodiment.

The design model component creation section 2112 creates a design model component based on information on a difference portion of design models detected by the common/difference information detection section 211, and stores the created design model component into the design model component information 2108. Moreover, the design model component creation section 2112 may be equipped with a function that allows the user to create a design model component.

The code component creation section 2113 creates a code template based on information on a difference portion of codes detected by the common/difference information detection section 211, and stores the created code component into the code component information 2109. Moreover, the code component creation section 2113 may be equipped with a function that allows the user to create a code component.

The business-related information creation section 212 associates business elements stored in the business element list 206 with information on created business process models, design models and codes. More specifically, the business-related information creation section 212 associates the business elements 302 with a business process template and business process components. In the same manner, the business-related information creation section 212 associates the business elements 302 with a design model template and design model components, and with a code model template and code components.

A procedure will now be described through which a user creates a template and a component from a plurality of business process models, design models and codes.

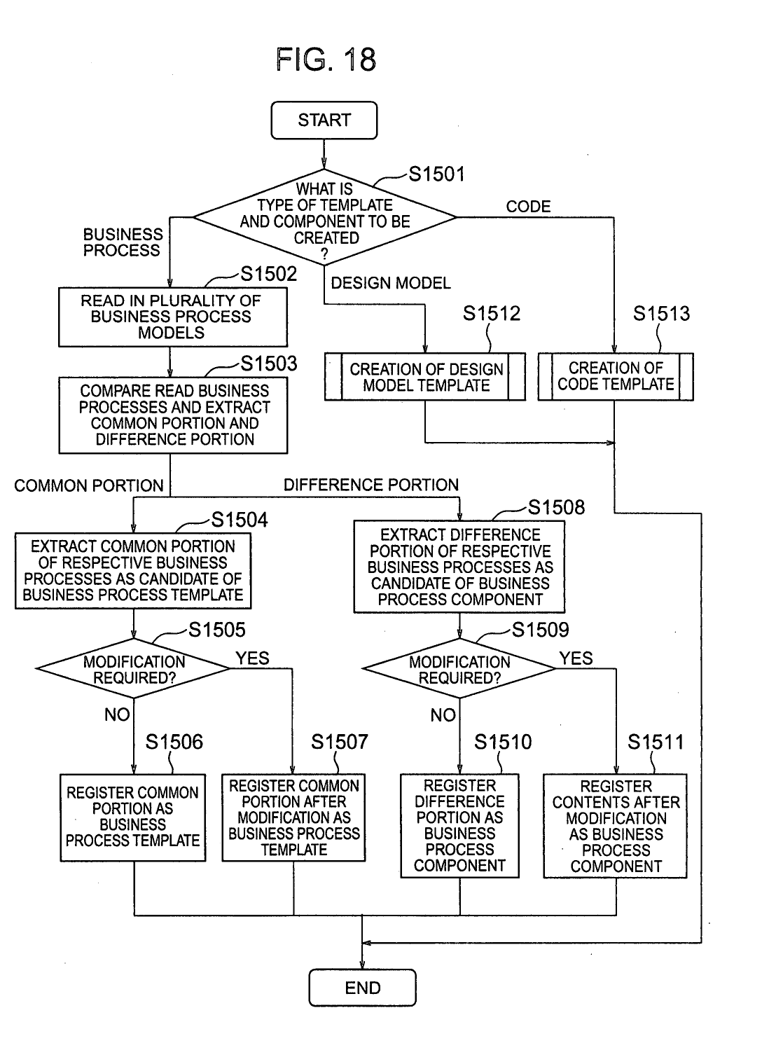

FIG. 18 is a flowchart showing a procedure for creating a template and a component from a plurality of business process models, design models and codes according to the fourth embodiment.

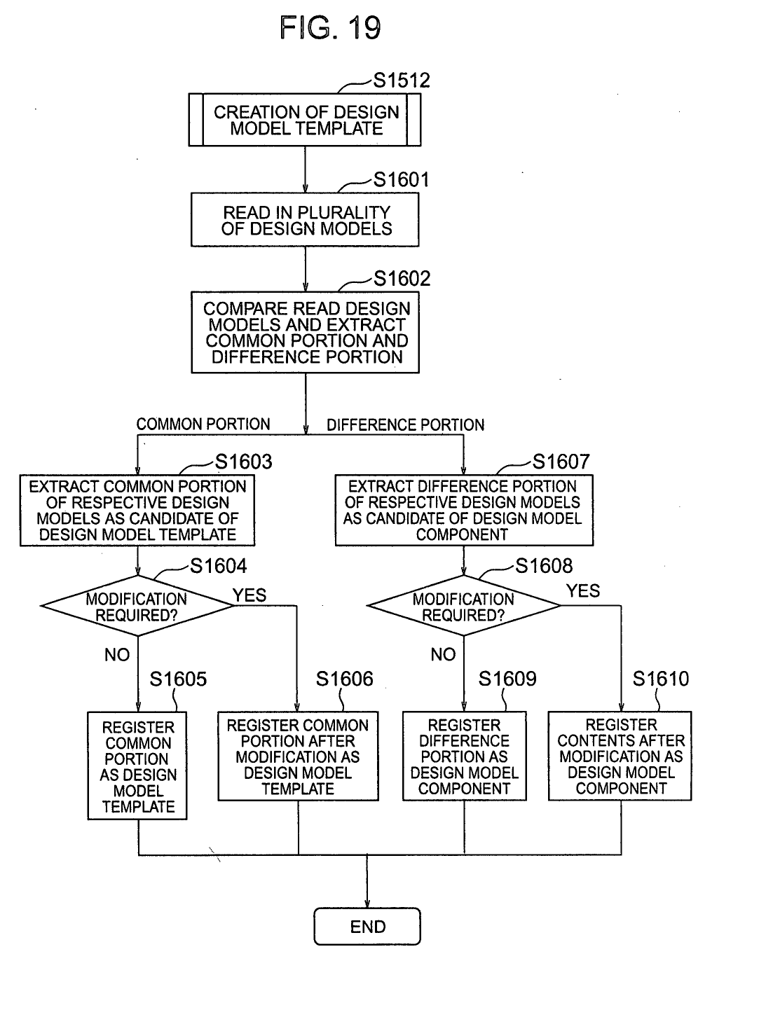

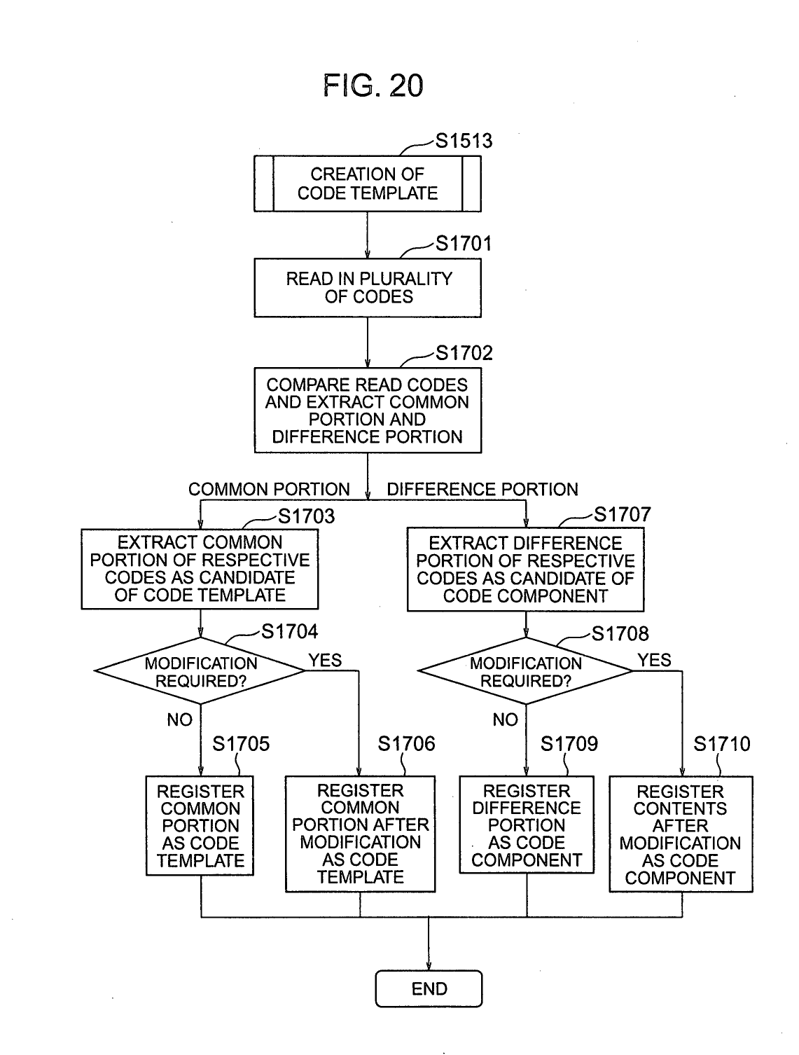

The CPU 103 first accepts input of the types of template and component to be created by the user (S1501). Processing in a case where “business process” is selected will be described below. Processing S1512 in a case where “design model” is selected will be described with reference to FIG. 19, while processing S1513 in a case where “code” is selected will be described with reference to FIG. 20.

The CPU 103 executes the common/difference information detection section 211, and reads in a plurality of business process models that have already been registered (S1502). In addition, the CPU 103 compares the read business process models, and extracts a common portion and difference portions of each business process model (S1503).

The CPU 103 extracts the extracted common portion as a business process template candidate (S1504). At this point, a region corresponding to a difference portion is considered to be a variable region.

Next, the CPU 103 presents the business process template candidate extracted through the processing of S1504 to the user to accept a determination of whether the contents thereof will be modified (S1505).

When it is determined that the contents are to be modified (a “YES” result in S1505), the CPU 103 modifies the contents extracted as a business process template candidate by executing the business process template creation section 209. The modified contents are then stored in the business process template information 205 as a business process template (S1507).

When it is determined that the contents are not to be modified (a “NO” result in S1505), the CPU 103 stores the contents extracted as a business process template candidate in the business process template information 205 as a business process template (S1506).

On the other hand, an extracted difference portion is considered to be a business process component candidate (S1508).

Next, the CPU 103 presents the business process component candidate extracted through the processing of S1508 to the user to accept a determination on whether the contents thereof will be modified (S1509).

When it is determined that the contents are to be modified (a “YES” result in S1509), the CPU 103 modifies the contents extracted as a business process component candidate by executing the business process component creation section 213. The modified contents are then stored in the business process component information 208 as a business process component (S1511).

When it is determined that the contents are not to be modified (a “NO” result in S1509), the CPU 103 stores the contents extracted as a business process component candidate in the business process component information 208 as a business process component (S1511).

Next, a procedure will be described for creating a design model template and a design model component when “design model” is selected through the processing of S1501.

FIG. 19 is a flowchart showing a procedure for creating a design model template and a design model component according to the fourth embodiment.

The CPU 103 executes the common/difference information detection section 211 and reads in a plurality of design models that have already been registered (S1601). In addition, the CPU 103 compares the read design models, and extracts a common portion and difference portions of each design model (S1602).

The CPU 103 extracts the extracted common portion as a design model template candidate (S1603). At this point, a region corresponding to a difference portion is considered to be a variable region.

Next, the CPU 103 presents the design model template candidate extracted through the processing of S1603 to the user to accept a determination of whether the contents thereof will be modified (S1604).

When it is determined that the contents are to be modified (a “YES” result in S1604), the CPU 103 modifies the contents extracted as a design model template candidate by executing the design model template creation section 2110. The modified contents are then stored in the design model template information 2105 as a design model template (S1606).

When it is determined that the contents are not to be modified (a “NO” result in S1604), the CPU 103 stores the contents extracted as a design model template candidate in the design model template information 2105 as a design model template (S1605).

On the other hand, an extracted difference portion is considered to be a design model component candidate (S1607).

Next, the CPU 103 presents the design model component candidate extracted through the processing of S1607 to the user to accept a determination of whether the contents thereof will be modified (S1608).

When it is determined that the contents are to be modified (a “YES” result in S1608), the CPU 103 modifies the contents extracted as a design model component candidate by executing the design model component creation section 2112. The modified contents are then stored in the design model component information 2108 as a design model component (S1610).

When it is determined that the contents are not to be modified (a “NO” result in S1608), the CPU 103 stores the contents extracted as a design model component candidate in the design model component information 2108 as a design model component (S1609).

Next, a procedure will be described for creating a code template and a code component when “code” is selected through the processing of S1501.

FIG. 20 is a flowchart showing a procedure for creating a code template and a code component according to the fourth embodiment.

The CPU 103 executes the common/difference information detection section 211, and reads in a plurality of codes that have already been registered (S1701). In addition, the CPU 103 compares the read codes, and extracts a common portion and difference portions of each code (S1702).

The CPU 103 extracts the extracted common portion as a code template candidate (S1703). At this point, a region corresponding to a difference portion is considered to be a variable region.

Next, the CPU 103 presents the code template candidate extracted through the processing of S1703 to the user to accept a determination of whether the contents thereof will be modified (S1704).

When it is determined that the contents are to be modified (a “YES” result in S1704), the CPU 103 modifies the contents extracted as a code template candidate by executing the code template creation section 2111. The modified contents are then stored in the code template information 2106 as a code template (S1706).

When it is determined that the contents are not to be modified (a “NO” result in S1704), the CPU 103 stores the contents extracted as a code template candidate in the code template information 2106 as a code template (S1705).

On the other hand, an extracted difference portion is considered to be a code component candidate (S1707).

Next, the CPU 103 presents the code component candidate extracted through the processing of S1707 to the user to accept a determination of whether the contents thereof will be modified (S1708).

When it is determined that the contents are to be modified (a “YES” result in S1708), the CPU 103 modifies the contents extracted as a code component candidate by executing the code component creation section 2113. The modified contents are then stored in the code component information 2109 as a code component (S1710).

When it is determined that the contents are not to be modified (a “NO” result in S1708), the CPU 103 stores the contents extracted as a code component candidate in the code component information 2109 as a code component (S1709).

According to the fourth embodiment, a business process template and a business process component may be newly created based on information on existing business process models. In addition, design models and codes may also be created in a similar manner as business process models. Therefore, standardization of components may be achieved through the utilization of business process models created prior to the introduction of the present system. Furthermore, the load caused by inputting business process templates and business process components necessary for the introduction of the present system may be reduced.

Moreover, even when information on existing business process models has not been digitized, such information may be scanned in using a scanner or the like to be converted into existing business process models. More specifically, as long as an existing business process model is described in a unified manner using a predetermined notation method, elements constituting the business process model may be extracted from image data scanned in by a scanner or the like based on the predetermined notation method. The same method may be applied to design models.

Furthermore, as for codes, it is now possible to automatically create codes in accordance with specific conventions for code templates and code components as long as source codes are described in the same programming language and in accordance with specific conventions.

### Fifth Embodiment

In the first to third embodiments, a business element was selected by a user after the selection of a business. However, a fifth embodiment is characterized in that a function is provided which presents a recommended combination of business elements by inputting predetermined creation conditions.

The hardware configuration of the fifth embodiment is the same as that of the first embodiment shown in FIG. 1. Hereinafter, a description of processing sections and data constituting the business process creation system according to the fifth embodiment will be provided, with an emphasis on points that differ from the first to fourth embodiments.

A software configuration of the business process creation system according to the fifth embodiment is the same as that of the business process creation system according to the third embodiment shown in FIG. 13.

After the user selects a business and a creation condition, the recommended combination information setting section 214 presents a combination of business elements corresponding to the selected business based on information stored in the business element list 206. In addition, the recommended combination information setting section 214 references recommended combination information 2114, and based on the specified business and creation condition, extracts a combination candidate that matches the condition.

The recommended combination information 2114 stores recommended combination candidates of business elements. The recommended combination information 2114 is stored in the storage device 106.

A description will now be given on a procedure in which the user selects a business and a creation condition, and a business element is selected with respect to the presented business element combination.

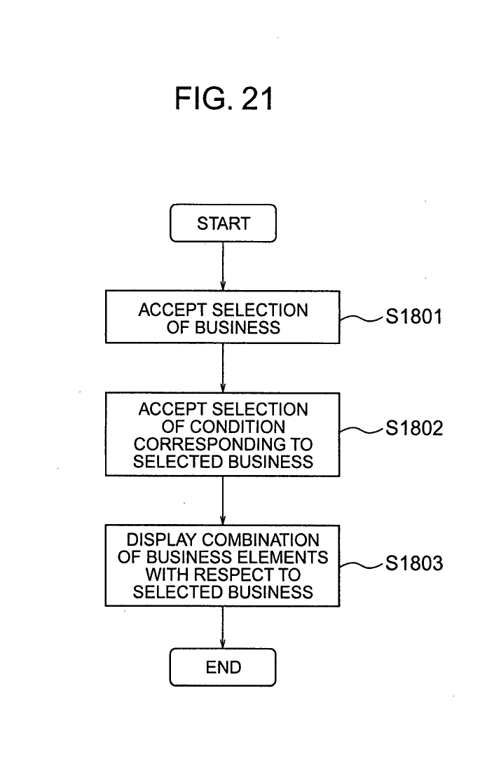

FIG. 21 is a flowchart showing a procedure for presenting a recommended combination for creating a business process model according to the fifth embodiment.

The CPU 103 executes the recommended combination information setting section 214 and accepts a selection of a business by the user (S1801). The CPU 103 further accepts an input of a creation condition (S1802). At this point, the CPU 103 may accept an input of a creation condition after accepting a selection of a business, or may concurrently accept the selection of a business and the input of a creation condition.

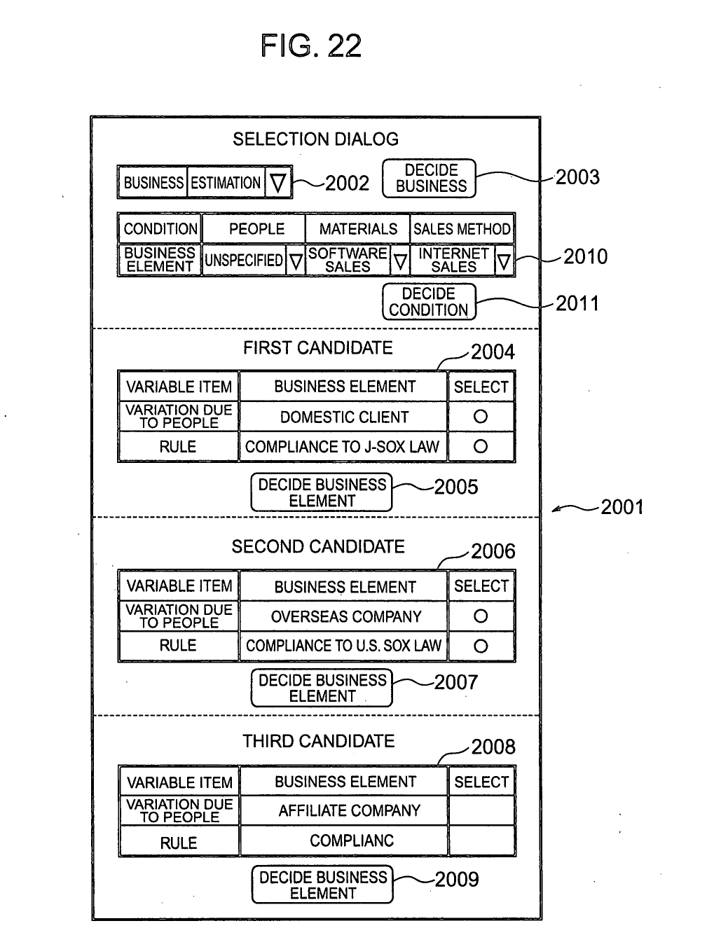

FIG. 22 is a diagram showing an example of a selection dialog 2001 for accepting business selection and creation condition input according to the fifth embodiment.

The selection dialog 2001 includes a business selection section 2002, a business decision button 2003, a condition selection section 2010, and a condition decision button 2011.

The business selection section 2002 stores a list of businesses. The list of businesses may be obtained by, for instance, retrieving businesses from the business element list 206 so as to avoid duplication of business names. The user selects a business for which a business process model is to be created from the business selection section 2002. After selection, the business decision button 2003 is operated to finalize business selection.

A creation condition may be arranged to be unselectable until the business decision button 2003 is operated, whereby a creation condition is set according to the decided business.

The condition selection section 2010 stores conditions of the business process model to be created. The condition selection section 2010 shown in FIG. 22 is configured so as to allow selection of variable factors in advance. A creation condition is finalized when one or more creation conditions are selected by the user and the condition decision button 2011 is operated.

Upon finalization of the creation condition, the CPU 103 displays candidates of business element combinations (S1803). Candidates of business element combinations are extracted based on a specified condition from recommended combination candidates retained in advance in the recommended combination information setting section 214.

Recommended candidates of business element combinations extracted by the recommended combination information setting section 214 are displayed in the selection dialog shown in FIG. 22. In addition, applicable laws are added as variable items.

Referring now to FIG. 22, a first candidate 2004, a second candidate 2006 and a third candidate 2008 are displayed. More specifically, as the first candidate 2004, a combination of “domestic client” as a “variation due to people” and “compliance to the J-SOX law” as a “rule” is presented as a recommended candidate. In addition, as the second candidate, a combination of “overseas company” as a “variation due to people” and “compliance to the US SOX law” as “rule” is presented as a recommended candidate. As seen, by storing, in advance, patterns such as the mandatory compliance to the Private Information Protection Law when conducting business with a domestic client or the mandatory compliance to the US SOX law when conducting business with an overseas client in the recommended combination information 2114, candidates of business element combinations may be presented.

The selection dialog shown in FIG. 22 is merely an example, and any selection dialog that allows the user to understand and acknowledge combination candidates shall suffice. In addition, a screen for inputting a business and a creation condition and a screen for displaying combination candidates may be provided separately.

Furthermore, a business element decision button (2005, 2007, 2009) is displayed for each candidate. Selection fields of the respective candidates may be checked by operating these buttons.

Finally, the CPU 103 creates a business process model based on the selected business element candidate. By selecting a candidate, in the event that the selection of business elements necessary for creating a business process model has been finalized, the business process model may be automatically created by executing the processing of S1105 and thereafter shown in the flowchart of FIG. 11.

When the selection of specified candidates is insufficient for deciding business elements, the CPU 103 may further display a screen for inputting information to accept input of additional information.

The fifth embodiment need not be limited to the creation of a business process model, and may be applied in a similar manner to the creation of a design model or a code.

According to the fifth embodiment, a business process model may be created without having to select all business elements. Consequently, the burden of creating a business process model may be reduced.

While preferred embodiments of the present invention has been described above, it is to be understood that various modifications may be made thereto without departing from the spirit and the scope of the following claims.

An analysis of business processes of businesses such as sales management which are carried out by many general companies is likely to reveal differences in business processes from one company to the next. It is conceivable that an analysis of business elements in business processes will basically result in primary differences with respect to: who, or difference in people; what, or difference in materials; how, or difference in sales methods; where, or difference in locations; when, or difference in time; why, or difference in company policies or in laws, and the like. Therefore, focusing on the factors described above and setting business elements accordingly makes it possible to accommodate various cases. Moreover, the present invention enables factors other than those described above to be set freely, thereby allowing even more businesses to be accommodated.

In the present invention, when creating a business process, modelization is performed by dividing the business process into a basic region that is a portion not influenced by variable factors such as described above and variable regions that is influenced by variable factors. Then, a business process model is created by allocating contents of a change in a business due to variable factors as a business process component to the variable region.

Furthermore, the present invention is even applicable to the creation of a design model and a code that is an ultimate deliverable in software development. By allocating, based on related information, a component created in advance to a range of the design model and the code that is influenced by variable factors in a business, a selection of a business and a business element enables the creation and modification of the design model and the code.

It should be further understood by those skilled in the art that although the foregoing description has been made on embodiments of the invention, the invention is not limited thereto and various changes and modifications may be made without departing from the spirit of the invention and the scope of the appended claims.

1. A system for supporting creating a business process comprising a processor and a storage device, wherein
the storage device stores:
a business element list including a business process template having a basic region in which constant processing is defined for each business and variable regions in which processing defined by a business element vary, and business elements included in the business process;
business process component information corresponding to the business elements and having business process components that constitute a portion of the business process, and
the processor creates a business process by:
accepting a selection of a business of the business process to be created;
acquiring, based on the selected business, a business process template and business elements corresponding to the business from the business element list;
accepting a selection of an acquired business element; retrieving, based on the selected business element, the business process component from the business process component information; and
allocating the retrieved business process component to a variable region of the acquired business process template.

2. The system according to claim 1, wherein the processor:
accepts input of a plurality of already-created business processes belonging to the same business;
extracts a common portion and a difference portion by comparing the inputted plurality of business processes;
stores the common portion as the business process template in the storage device; and
stores the difference portion as the business process component in the storage device.

3. The system according to claim 1, wherein, when a plurality of business elements is selected for the variable region, the processor adds a branch condition to the variable region, arranges the selected plurality of business elements in parallel, and allocates the plurality of business elements to the variable region.

4. The system according to claim 1, wherein the business element list includes a correspondence relationship between the business element and a design model template that is a template of a software design model,
the storage device further stores design model component information corresponding to the business element and which includes a design model component that constitutes a portion of the design model,
the design model template includes a basic region in which constant contents are defined for each business and variable regions in which contents vary according to the business element, and
the processor creates a design model by:
accepting a selection of a business;
acquiring, based on the selected business, a design model template and business elements corresponding to the business from the business element list;
accepting a selection of an acquired business element; retrieving, based on the selected business element, the design model component from the design model component information; and
allocating the retrieved design model component to a variable region of the acquired design model template.

5. The system according to claim 1, wherein
the business element list includes a correspondence relationship between the business element and a code template that is a template of a program code,
the storage device further stores code component information corresponding to the business element and which includes a code component that constitutes a portion of the program code,
the code template includes a basic region in which constant processing is defined for each business and variable regions in which described processing vary according to the business element, and
the processor creates a program code by:
accepting a selection of a business;
acquiring, based on the selected business, a code template and business elements corresponding to the business from the business element list;
accepting a selection of an acquired business element;
retrieving, based on the selected business element, the code component from the code component information; and
allocating the retrieved code component to a variable region of the acquired code template.

6. The system according to claim 1, wherein
the storage device stores recommended combination information including a recommended combination of business elements, and
the processor creates a business process by:
accepting a selection of a business of the business process to be created;
acquiring, based on the selected business, a business process template corresponding to the business from the business element list;
accepting an input of a creation condition of the business process to be created;
retrieving a business element combination from the recommended combination information based on the inputted creation condition;
retrieving, based on the retrieved business element, the business process component from the business process component information; and
allocating the retrieved business process component to a variable region of the acquired business process template.

7. A method for supporting creating a business process, the method storing:
a business element list including a business process template having a basic region in which constant processing is defined for each business and variable regions in which processing defined by a business element vary, and business elements included in the business process; and
business process component information corresponding to the business elements and having business process components that constitute a portion of the business process, wherein
the method creates a business process by:
accepting a selection of a business of the business process to be created;
acquiring, based on the selected business, a business process template and business elements corresponding to the business from the business element list;
accepting a selection of an acquired business element; retrieving, based on the selected business element, the business process component from the business process component information; and
allocating the retrieved business process component to a variable region of the acquired business process template.

8. The method according to claim 7, wherein the method:
accepts input of a plurality of already-created business processes belonging to the same business;
extracts a common portion and a difference portion by comparing the inputted plurality of business processes;
stores the common portion as the business process template in the storage device; and
stores the difference portion as the business process component in the storage device.

9. The method according to claim 7, wherein, when a plurality of business elements is selected for the variable region, the method adds a branch condition to the variable region, arranges the selected plurality of business elements in parallel, and allocates the plurality of business elements to the variable region.

10. The method according to claim 7 storing recommended combination information including a recommended combination of the business elements, wherein
the method creates a business process by:
accepting a selection of a business of the business process to be created;
acquiring, based on the selected business, a business process template corresponding to the business from the business element list
accepting an input of a creation condition of the business process to be created;
retrieving a business element combination from the recommended combination information based on the inputted creation condition;
retrieving, based on the retrieved business element, the business process component from the business process component information; and
allocating the retrieved business process component to a variable region of the acquired business process template.

11. A computer-executable program for supporting creating a business process, the program comprising the procedures of:
accepting a selection of a business of the business process to be created;
acquiring, based on the selected business, a business process template and business elements corresponding to the selected business from a business element list that includes a business process template having a basic region in which constant processing is defined for each business and variable regions in which processing defined by a business element vary, and business elements included in the business process;
accepting a selection of an acquired business element;
retrieving, based on the selected business element, a business process component that constitutes a portion of the business process; and
allocating the retrieved business process component to a variable region included in the acquired business process template.
